(19) United States
(12) Patent Application Publication
(10) Pub. No.: US 2024/0376870 A1
(43) Pub. Date: Nov. 14, 2024

(54) Circumferential engine

(71) Applicant: Wenlin REN, Wuhan (CN)

(72) Inventor: Wenlin REN, Wuhan (CN)

(21) Appl. No.: 18/572,499

(22) PCT Filed: May 13, 2023
(86) PCT No.: PCT/CN2023/094093

§ 371 Date: Dec. 20, 2023

(51) Int. Cl. F03G 3/00; F03G 3/08

(52) U.S. Cl. CPC F03G 3/087; F03G 3/00; F03G 3/08

(57) ABSTRACT

This invention is a type of engine that introduces new methods and devices for harnessing the solid potential energy of circular bodies as a natural resource. It includes circular bodies with shafts and suspended circular bodies for stable operation and effective power transmission. Weighted, external force, and magnetic circular bodies indefinitely amplify potential energy. The combination of a prime mover, circular body, and circular motion results in output exceeding input, equating to infinite energy and the realization of a perpetual motion machine. This overcomes the conventional limitation of output not exceeding input. With zero consumption, emissions, and pollution, it provides humanity with abundant clean and inexpensive new energy sources. It addresses the limitations of fossil fuels, such as limited availability, high costs, and severe pollution, offering a viable alternative as a primary energy source for humanity. It aids in overcoming energy and environmental crises, with natural energy being ubiquitous and inexhaustible, more convenient, and less costly than hydro and wind power. Simplifying complex systems is challenging, yet this invention achieves simplicity and practicality over conventional technology. Access to sufficient clean and inexpensive energy can fulfill all needs. The invention addresses the significant energy crisis while tapping into the vast, untapped natural energy resources.

I: Technical Field: This invention belongs to the field of energy, specifically engines that have zero consumption, zero emissions, and zero pollution.

II: Technical Background: Possessing energy means possessing everything. Ancient biomass energy nearly destroyed the Earth's vegetation. Today's fossil fuels are almost destroying the human environment. Including hydro, wind, and solar energy, all known energy sources are limited and costly, unable to meet the developmental needs of humanity. Humans have been desperately seeking clean, inexpensive energy sources, striving for an engine that is infinitely abundant, with zero consumption, zero emissions, and zero pollution. The inventor's previous patent applications Ser. No. 20/061,0115181.8 “Gravity Car”, 201110106455.8 “Method for Obtaining Gravity Energy and Gravity Energy Saving Oil Pump”, 201711256605.7 “Gravity Engine”, and 201510207863.0 “Circular Motion Device” have disclosed some content. This application is a subsequent invention. Over 20 years ago, the inventor discovered a circular law different from traditional theories, namely the law of circular motion, which is the theoretical basis of this invention. This application makes slight modifications to the previously disclosed Circular Laws 1-6, adds Circular Laws 7-10, and discloses them as follows:

### First Law: The Gravity Profile Causes the Static Mass of the Circular Body to be Zero

“In a gravitational field, a uniformly massed circular body (here referring to a sphere or cylinder), when in ideal point or line contact with a solid, horizontal bearing surface, has its mass divided into two by gravity. This division occurs along a plane within the body, known as its gravity profile. Due to structural reasons, the gravitational forces on either side of this gravity profile are equal in magnitude but opposite in direction, resulting in a balance of forces that act as either resistance or propulsion. The ‘opposite direction’ refers to the direction of motion caused by gravity. Its stationary inertia is independent of its mass. Regardless of the mass, the stationary inertia is zero, meaning the mass is effectively zero, and the force required to overcome this stationary inertia is greater than zero. The following scenario is possible: during motion, always half of the gravity becomes a resistance or propulsive force, with the force overcoming motion inertia being greater than any external force applied.”

Explanation of the First Law: The term “uniform mass” refers to an even distribution of mass. Circular bodies with uneven mass distribution also adhere to the Circular Laws to varying degrees. The term “circular body” refers to objects with a gravity profile, including spheres, cylinders, and non-circular bodies. Cylinders include objects like wheels. Non-circular bodies refer to objects, other than spheres and cylinders, that undergo circular motion. Any object that undergoes circular motion is a circular body. All circular bodies follow the Circular Laws. Non-circular bodies only become circular bodies when they undergo circular motion. Rolling, rotating, swaying, swinging, and rocking are all forms of circular motion. Rolling and rotating can occur without an axis and may involve displacement. Rotations with an axis cannot involve displacement. The drum of a ball mill rotates, a wheel combines rolling and rotating in a compound motion. A roly-poly toy sways, a swing swings, and a seesaw rocks. Walking involves the alternate swinging of legs and the swaying of the entire body. A circular body lever that cannot roll due to a fixed pivot point also follows the principles of levers. The “solid, horizontal bearing surface” refers to a non-deformable, horizontally oriented surface. “Ideal state” refers to the condition where the bearing surface does not indent, and the radius of the circular body in contact with the surface does not shorten. The contact radius refers to the radius from the center of the circle to the bearing surface, in contrast to the original radius, which is the inherent radius of the body. For example, a wheel, a type of cylindrical circular body, ideally contacts the ground along a line. Pneumatic wheels often have a contact radius shorter than their original radius and contact the ground over a surface, not ideally a line, hence greater rolling resistance. Circular bodies in non-ideal states also adhere to the Circular Laws to varying degrees. The First Law is also known as the “Gravity Profile Law.” The “gravity profile.” also called the “gravity dividing plane.” refers to the plane in a circular body where the gravitational forces on either side are equal and opposite in direction. The gravity profile always lies along the extended line connecting the pivot of the circular body to the center of the earth. While the gravity profile is invisible, it objectively exists. Although the direction of gravity is downwards, due to structural reasons, the gravitational forces on either side of a circular body's gravity profile are equal in magnitude and opposite in direction. For instance, when a sphere or cylinder contacts a bearing surface at a point or a line, its pivot sides are suspended in air, and the gravitational forces on either side of the gravity profile cause motion in opposite directions. A stationary circular body has a net gravitational force of zero, an inertial force of zero, equating to a mass of zero. Any object with a gravity profile follows the Circular Laws in motion. A moving circular body can automatically adjust the gravitational forces on either side of its gravity profile to be equal and opposite, achieving a balance of forces. The application of the “Gravity Profile Law” is extensive, explaining physical phenomena such as the stability of a spinning top, the balancing of bowls in acrobatics, and the case of rolling motion. The First Law is foundational, and the following content is derived and developed based on it.

### Second Law: f≠ma, Forces on an Inclined Plane, Rotation Around an Axis, High-Speed Rotation, Centrifugal Force

According to the First Law, the following situations can exist: For a circular body (sphere or cylinder) experiencing force, the magnitude of acceleration it undergoes is proportional to the force applied, irrespective of its mass. The same external force can roll circular bodies of different masses, producing the same acceleration. Regardless of the mass of the circular body, its impact on rolling remains the same. Here, f=ma does not hold, hence f≠ma. This is because “m” becomes 1, a constant. All formulas or theories involving “m” are thus flawed.

When the horizontal bearing surface of the First Law becomes an inclined plane, the following situations can exist:

On an inclined plane, a circular body with an upward tendency has its gravity profile not located at the center. The gravitational forces on either side of the gravity profile are unequal, with more than half of the gravity becoming resistance. The magnitude of the acceleration produced by the force is directly proportional to the force applied and inversely proportional to the mass.

On an inclined plane, a circular body with a downward tendency has its gravity profile not at the center, with unequal gravitational forces on either side, where more than half of the gravity becomes a driving force. The magnitude of acceleration produced by the force is directly proportional to the force and the mass.

On an inclined plane, whether moving up or down, the gravity profile of the circular body always lies along the extended line connecting the pivot to the center of the earth.

A circular body rotating around an axis, regardless of mass, requires a force greater than the friction at the bearing to overcome its static inertia and a force greater than any external force to overcome its motion inertia. A circular body rotating around an axis has energy storage capabilities during rotation.

Circular bodies in motion, either moving at high speeds or in a straight line, are in compound motion and do not fully adhere to the aforementioned Circular Laws. The faster they change spatial position, the more they deviate from the Circular Laws.

High-speed rotating circular bodies exhibit centrifugal weightlessness. The higher the speed, the greater the centrifugal force, and the more pronounced the weightlessness. Regardless of mass, the force required to overcome their static inertia is greater than the friction at the bearing point, and the force to overcome their motion inertia is greater than any external force applied.

### Third Law: Circular Lever, Large Wheel Transmission

According to the First Law, combined with practical application, the following situations can exist when rolling a circular body:

When the point of application of the force is at the bottom of the circular body, the focus is at the center, and the point of force is at the top of the circular body. If the power arm is twice as long as the resistance arm, half the force can be saved, and the resultant gravitational force is twice the applied force. This is similar to a dynamic pulley. Commonly known rim-driven wheels fall into this category.

When the point of application of the force is at the bottom of the circular body, the focus is below its center, and the point of force is at the top. If the power arm is more than twice as long as the resistance arm, more than half the force can be saved, making it a force-saving lever, with the resultant gravitational force being more than twice the applied force. Commonly known large wheel transmission methods fall into this category.

When a wheel (circular body) carries a heavy object through a swinging structure, and the heavy object can swing relative to the wheel, the wheel's gravity profile changes with the swing. More than half of the gravity becomes either resistance or propulsion, with the force overcoming the wheel's static inertia being greater than the friction at the pivot of the swing. Driving the wheel to roll can generate gravitational force more than twice the applied force.

### Fourth Law: Solid High-Position Gravitational Potential Energy and Potential Energy Zone

A circular body possesses solid high-position gravitational potential energy. In horizontal rolling, a circular body can perpetually maintain solid high-position gravitational potential energy. A circular body has a solid high-position gravitational potential energy zone. The area beneath the circular body, including the surroundings of the contact point or both sides of the contact line, is its solid high-position gravitational potential energy zone, referred to as the “potential energy zone.” The gravitational energy of the circular body can be harvested from the circular body itself or from its potential energy zone. The solid high-position gravitational potential energy of a circular body has greater density, wider distribution, is more environmentally friendly, and is easier to collect than the high-position gravitational potential energy of fluids. The solid high-position gravitational potential energy of a circular body is a natural law inherent from birth and a gift bestowed upon humanity by the heavens.

### Fifth Law: Moving Circular Bodies Can Gain Potential Energy

Moving circular bodies can harness their gravitational potential energy. Rolling a circular body along a suitable inclined plane can save more than half the effort. A rolling circular body can generate the same amount of gravity and gravitational potential energy at every point or line along its rolling path. The gravitational forces on either side of the gravity profile of a rolling circular body continuously change. The more gravity that becomes propulsion, the more effort is saved. The energy gained by a rolling circular body can far exceed the energy expended. Rolling circular bodies can generate surplus energy. Moving circular bodies can create solid high-position gravitational potential energy. Moving circular bodies can produce an infinite amount of gravitational energy. The motion referred to here is circular motion.

### Sixth Law: The Principle of the Convex Point and its Applications

The “Gravity Transformation Device” utilizes a method of continuously restoring and releasing the gravitational potential energy of a circular body to transform its gravitational potential energy.

The “Gravity Transformation Device” includes convex points set in the potential energy zone of a circular body. These convex points receive and transmit the gravity of the circular body, transforming gravity into propulsion. The convex points can be higher than the bearing surface of the circular body, creating resistance to its rolling. The force required to roll the circular body increases with the height of the convex points. The higher the convex point, the more effort is required. The lower the convex point, the less effort is needed. As long as the convex point is within the potential energy zone of the circular body, gravity can be transformed into propulsion. As long as the force exerted by the rolling circular body to compress the convex point is less than the gravity of the circular body, surplus energy can be generated. The method of gravitational force output by the circular body can vary. The structural form of the convex points can change; they can be transformed into gears, connecting rods, levers, or push rods. For example, a convex point can be transformed into a connecting rod attached to the potential energy zone of the circular body, transmitting to a crankshaft. Convex points are humanity's means of energy harvesting. The solid high-position gravitational potential energy of a circular body is infinite and inexhaustible, capable of limitless transformation. The “Gravity Transformation Device” only needs an initial force to start, then it can move perpetually, self-sustaining with surplus energy, providing infinite power to humanity. This phenomenon does not violate the law of conservation of energy because the energy of the “Gravity Transformation Device” comes from the continuous transformation of the solid gravitational potential energy of the circular body, namely the earth's constant and endless gravitational pull on the circular body. Thus, the Circular Laws are also laws of energy. The initial force mentioned refers to the driving power of the circular body.

### Seventh Law: Energy Formula 1×1=N×1

The energy formula 1×1=N×1 means that the force 1×travel distance 1 of the force equals the propulsion N×travel distance 1 of the circular body. That is: 1=N. N can be much greater than 1; N can be infinitely large. Therefore, infinite energy can be obtained.

This formula indicates that by giving one, one can receive N, countless returns, a highly profitable return on investment.

Example: Driving a 500-kilogram cylinder (circular body) with a force of 50 kilograms at its center to roll up and down an inclined plane of about 5 degrees, with a travel distance of 1 decimeter. This cylinder can generate “potential energy force of over 500 kilograms,” far exceeding the applied force of 50 kilograms. Potential energy force refers to the propulsion generated by the circular body in motion. This force is derived from the applied force, the gravitational force of the circular body, and its inertial force. It has been proven that the potential energy force is much greater than the applied force, and the force required to restore potential energy is much smaller than the potential energy force. Using an equal-arm lever conversion device, this “potential energy force of over 500 kilograms” can be converted into an applied force of over 500 kilograms. The formula is: Applied force 50 kilograms X travel 1 decimeter =Cylinder 500 kilograms X travel 1 decimeter. This means 50=500, or 1=50, thus 1=N. Repeating this action continuously, one can keep generating a potential energy force of over 500 kilograms, thereby obtaining a continuous supply of power. This is an undeniable fact. Transforming this fact into a machine that continuously outputs power is known as the Circular Engine. Adjusting the slope of the inclined plane or the ratio of the applied force to the weight of the circular body can generate even greater potential energy force. In fact, we can almost infinitely magnify the N in the formula 1×1=N×1, thus obtaining infinite energy.

This fact proves that the law of conservation of energy is incorrect in circular motion. Energy can be created, and perpetual motion machines are feasible. Indeed, there are many other ways to achieve perpetual motion and numerous methods to harness new energy sources, which are not disclosed at this time. Applying the Circular Laws of the driving force+circular body+circular motion=output greater than input=perpetual motion machine is one of the most realistic and effective ways to achieve a perpetual motion machine, meeting human needs. Energy is everything. With enough clean and inexpensive energy, everything is possible, liberating humanity, bringing us infinitely closer to becoming god-like, and realizing mankind's millennia-old dream. However, it's regrettable that for 16 years, people have not recognized, acknowledged, or adopted the Circular Laws and inventions.

The force required to restore the potential energy of a circular body on a suitable inclined plane is much smaller than its potential energy force. This is the factual basis of this theory. The formula 1×1 =N×1 can vary according to the actual situation. When the applied force is at the top of the circle, and the diameter and travel distance of the force are twice that of the cylinder, the formula becomes: 1 (one unit of force)×2 =N×1, i.e., 2=N.

The potential energy force of the circular body mentioned refers to the propulsion of the circular body. The applied force mentioned in this invention can be the driving force.

### Eighth Law: Energy and Work Creation, Saving Effort and Work

The energy formula 1×1=N×1 proves that circular motion can save both effort and work, and circular motion can create work. Therefore, in circular motion, the theory of saving effort without saving work is incorrect, failing to reflect the law of circular motion, and is not factual.

Within the same period, using tools or machinery, a smaller force can yield a larger force. Within the same period, using tools or machinery, a smaller amount of work can yield a greater amount of work. Within the same period, using tools or machinery, a smaller amount of energy can yield a greater amount of energy. Regardless of the tools or machinery used, creating a larger force from a smaller one is essentially creating force. Regardless of the tools or machinery used, creating a larger amount of work from a smaller one is essentially creating work. Regardless of the tools or machinery used, creating a larger amount of energy from a smaller one is essentially creating energy. The output is greater than the input.

Nature is wondrous, and forces, work, and energy can be created. The law of conservation of energy is incorrect in circular motion. Newton's laws and the law of conservation of energy cannot explain circular motion, nor can they be used to test or oppose the Circular Laws.

### Ninth Law: A Reasonably Structured Circular Body is a Source of Energy

A circular body with a reasonable structure can become a source of energy, capable of creating an infinite amount of clean, cheap energy. Almost all objects can become circular bodies, undergo circular motion, and achieve output greater than input. The key lies in the structure and mode of motion of the circular body. Circular bodies with a reasonable structure include: axial circular bodies, pivot circular bodies, drum circular bodies, suspension circular bodies, counterweight circular bodies, external force circular bodies, lever circular bodies, large wheel circular bodies, elastic force circular bodies, magnetic force circular bodies, wheel axle circular bodies, crankshaft circular bodies, and combined circular bodies.
1. Axial circular bodies refer to circular bodies with an axis. The axis includes a central axis, an offset axis, or a combination of both; the central axis refers to an axis at the center of the circle, including circular bodies transformed from gears, wheels, pulleys. An offset axis means the axis is outside the center, including eccentric wheels. A combination of a central and offset axis refers to a circular body having both on it. The central axis can move up, down, left, right in the axle hole or/and make elastic contact with the axle hole, vibrating slightly in various directions relative to the axle hole, i.e., small-scale regular vibration. Conversely, the axle hole can move or/and make an elastic connection relative to the central axis. Axial circular bodies are controlled circular bodies, operating more smoothly and efficiently than non-axial ones, and are easier to implement.
2. Pivot circular bodies refer to circular bodies with reasonable pivots. The pivot is the point supporting the circular body. At a reasonable pivot, the gravitational forces on either side of the circular body's gravity profile are equal or nearly equal, or tend to be equal, and the force required to overcome static inertia is greater than zero or tends towards zero. A reasonable pivot can have the longest possible power arm or the shortest possible resistance arm; it can maximize the release of the circular body's potential energy force. All movements should and can establish reasonable pivots, establish reasonable gravity profiles, and can be pivot circular bodies.
3. Suspension Circular Bodies refer to circular bodies with a suspension system. This suspension is the mechanism for mounting the circular body, and it is movably connected to the base. The suspension can be flat, grid-like, or frame-like, and may include elasticity; this elasticity can assist the suspension in returning to position or act as an external force on the suspension. The elasticity can come from elastic materials, springs, or/and elastic devices, including pneumatic or hydraulic elastic devices. The movable connection includes joints with gaps or/and elasticity, allowing the circular body in motion to move forward, upward, backward, and downward within a certain range along with the suspension relative to the base. There can be upper stops or/and lower pivot points or/and limit springs or other limiting devices to restrict the range of forward, upward, backward, and downward movement of the cylinder or suspension. When mounted on the suspension, the circular body can be suspended in motion, stably and efficiently transferring potential energy force. This potential energy force refers to the power generated by the circular body in motion, derived from the body's gravity and its inertial force during movement. The suspension includes cantilevers, diagonal frames, vertical frames, booms, upper seats, or sedan bars; suspension circular bodies can have counterweights or/and external forces. The weight of the suspension can also act as a counterweight; driving a suspension circular body on a reasonable pivot can yield potential energy force far greater than the driving force, and the force to restore its potential energy is much smaller than its potential energy force. This potential energy force is the circular body's power; the circular body can also move forward, backward, upward, and downward relative to the suspension.
4. Drum Circular Bodies refer to circular bodies that are drums, located on pivot wheels and have a reasonable gravity profile. ‘Reasonable’ includes equal or nearly equal gravitational forces on either side of the gravity profile, and the force to overcome static inertia being greater than zero or tending towards zero. Commonly known drum machines like ball mills, dryers, and mixers can establish reasonable pivot wheels, becoming drum circular bodies, saving energy. The pivot wheel is located near the vertical centerline underneath the drum. The pivot wheel can be a gear, friction wheel, toothed hole wheel, or chain wheel. The drum or/and pivot wheel can cooperate with a generator to produce electricity, not only not consuming energy but also outputting energy.
5. Counterweight Circular Bodies refer to circular bodies with counterweights. Counterweights mean adding weight to increase the circular body's weight and potential energy force. Counterweights can change the gravitational forces on either side of the circular body's gravity profile, making it easier to move and saving driving force. Counterweights include dynamic and static counterweights, movable and fixed counterweights. Dynamic counterweights move with the circular body, while static counterweights do not. Movable counterweights are movably connected to the circular body, such as weights hung on the circular body or its axis. Fixed counterweights are firmly connected to the circular body or related devices. Counterweights can be placed on the circular body, its axis, or suspension. Hanging counterweights set in the forward downward direction of the circular body do not affect the body's downward movement, nor do they affect the transmission of potential energy force; counterweights can be greater than resistance, sufficient counterweights can overcome all resistance, can output more than input, becoming a source of strength.
6. External Force Circular Bodies refer to circular bodies with external forces; these are forces other than the driving force. External forces include tension and/or pressure and/or magnetic force and/or elastic force; they can increase the potential energy force of the circular body; they can alter the gravitational forces on either side of the circular body's gravity profile, making it easier to drive and saving on driving force; external forces work in conjunction with the driving force on the circular body; external forces can be applied to the circular body, its axis, or related devices; external forces can rotate with the circular body or not rotate with it; gravity and external forces can be transformed into each other. External forces can be greater than resistance; sufficient external forces can overcome all resistance, can produce output greater than input, becoming a source of strength.
7. Lever Circular Bodies, also known as circular body levers, can be cylindrical, bowl-shaped, ring-shaped, disc-shaped, or tube-shaped. They have pivots, focuses, and points of force, and use well-known methods of transmitting potential energy force.
8. Large Wheel Circular Bodies refer to circular bodies using well-known large wheel transmission methods. This involves transforming large wheel transmission structures into circular bodies.
9. Elastic Force Circular Bodies refer to circular bodies that possess elasticity, including those with elastic materials, springs, or elastic devices; they include a gap and/or elasticity between the circular body's axis and axle hole, allowing the circular body to move slightly up, down, left, and right relative to the axle hole; the purpose of having a gap and/or elasticity is to increase the potential energy force of the circular body or/and release its potential energy force more effectively.
10. Magnetic Force Circular Bodies refer to circular bodies with magnetic forces, capable of receiving magnetic drive. They can assist the driving force or act as the driving force.
11. Wheel Axle Circular Bodies refer to circular bodies with wheel axle mechanisms. This includes well-known pulleys, gears, chain wheels, or flywheels.
12. Crankshaft Circular Bodies refer to circular bodies that are crankshafts or have crankshafts. The crankshaft connects to connecting rods, outputting the potential energy force of the circular body.
13. Combined Circular Bodies refer to a combination of multiple circular bodies or multiple stamping components to form a circular body. The combination of circular bodies is an accumulation of forces. The potential energy force point of one circular body becomes the driving force for the next. Multiple small circular bodies combine to form a larger circular body. For example, a combination of multiple pulley devices, where the potential energy force of one pulley acts as the driving force for the next, adding force cumulatively; for instance, combining multiple magnetic circular bodies with large wheel circular bodies and internal gear circular bodies, using the potential energy force of one as the driving force for the next. infinitely magnifying the potential energy force. The term ‘combination’ includes creative combinations as well as simple stacking, including horizontal arrangements, vertical arrangements, and radial or/and axial combinations. For example, multiple internal gear circular bodies or large wheel circular bodies can be combined axially. Stamping component combination is a type of circular body structure and processing method. It facilitates processing and maintenance, reduces damage and waste, and lowers costs, increasing the variety of circular bodies. For example, disassembling a gear axially or radially, processing it into multiple stamping components, and then recombining them axially or radially into a gear. Disassembling a spherical, cylindrical, or bowl-shaped circular body axially or radially, processing it into multiple stamping components, and then recombining them axially or radially into a circular body. Various different structured circular bodies can be combined for use.

Circular body transmission methods can include: A) Central axis transmission, i.e., transmission through the center of the circle, such as the commonly known transmission shaft in automobiles. B) Wheel axle transmission, like a steering wheel. C) Offset axis transmission, like an eccentric wheel. D) Circular top transmission, which is transmission at the top of the circular body. Both axial and non-axial circular bodies can use circular top transmission, which is the most energy-efficient due to the longest lever arm.

The circular body is an abstract, higher-level concept created to summarize the natural laws of circular motion and to explain and disseminate the Circular Laws. It is a theoretical concept. Circular bodies in invention applications are concrete objects, and there is a gap between the theoretical concept and the concrete object. The circular body must be interpreted and identified according to specific circumstances. For instance, objects or devices like gears or wheels used for transforming potential energy force can be considered circular bodies. Clearly, this abstract and higher-level concept should not be used to strictly demand or limit the concrete objects in inventions. The concept of the circular body should be used according to specific circumstances to help disseminate science and correctly interpret patent claims.

Obviously, there is a significant difference between explaining the properties and rules of a discovery and explaining the structural features of an invention.

### Tenth Law: Zero Consumption, Zero Emission, Zero Pollution Circular Engine

According to the aforementioned Circular Laws, it is possible to achieve a circular engine with zero consumption, zero emissions, zero pollution, and output greater than input. Driving force+circular body+circular motion=output greater than input=an infinitely vast source of clean, cheap new energy. This is the natural energy formula. Almost all forms of power can become the driving force, almost all objects can become circular bodies, and almost all movements can become circular motion, all capable of producing output greater than input, thus becoming a circular engine. The driving force and circular bodies are readily available, widely existing, and easily accessible. Therefore, output greater than input is also readily available, widely existing, and easily accessible. An infinitely vast source of clean, cheap new energy is also readily available, widely existing, and easily accessible. This is the natural energy bestowed upon humanity by the heavens, the most beautiful gift to mankind. Unfortunately, for 16 years, humanity has not recognized, acknowledged, or adopted it. The circular engine has at least seven generations with seventy different structures. The first generation is the reciprocating engine. The second generation is the rotary engine. Using driving force to move a circular body in reciprocating or rotating motion, transforming gravity into work. It can be used for power generation or as engines for trains or ships. The third generation is counterweight and external force engines, transforming counterweights and external forces into work. They are compact with high energy density. They can generate power or be used as engines for cars, trains, ships, and airplanes. The fourth generation is a wheel axle engine combined with multiple pulley devices. The fifth generation is the crankshaft engine. The sixth generation is the concentric engine. The seventh-generation central engine can be used for spacecraft, capable of near-light-speed travel. The theoretical basis: first, the Circular Laws discovery that the mass of an object can become zero. The First Law reveals the principle of static mass being zero, leading to the invention of three generations of circular engines. Subsequent undisclosed Circular Laws reveal the principle of mass in motion being zero. If an object's mass in motion is zero, it can reach the speed of light. Second, the circular engine can provide an infinitely vast source of clean, cheap energy in space, creating the necessary energy conditions to approach and ultimately reach the speed of light. Third, the discovery of the mystery of cosmic light speed and finding methods to apply this mystery led to the design of accelerators and light-speed spacecraft that can approach or ultimately reach light speed, using space conditions to achieve near or actual light speed.

Example 1: An axial cylindrical body (a type of circular body) is mounted on a suspension, with one or more protrusions set on the surface of the circular body, including ribs, serrations, or wheels. The driving force moves the axial circular body in reciprocating, rolling, or rotating motion, and the protrusions transfer pressure to a connecting rod, lever, or transmission bar to perform work. The pressure is potential energy force. The height of the protrusions determines the work stroke of the circular body.

Example 2: Driven by a driving force, the upper gear, middle gear, and lower gear transmit power sequentially. The upper and middle gears are mounted on a suspension, movably connected to the base, and can include counterweights and/or external forces. External forces comprise pressure and/or tension and/or elastic force and/or magnetic force. Apart from the driving force, the counterweights and external forces on the middle gear and its pivot position on the lower gear determine the potential energy force of the middle gear. That is, the potential energy force of the middle gear is mainly determined by the counterweights and/or external forces on it and their pivot position on the lower gear. The middle gear is located near the vertical centerline above the lower gear. The meshing point between the middle and lower gears is the pivot point of the middle gear on the lower gear. The counterweights and/or external forces and their pivot point on the middle gear ensure that the gravitational forces on either side of the middle gear's gravity profile are nearly equal. Therefore, the upper gear can easily overcome the resistance of the middle gear. The resistance of the middle gear refers to its static inertia. Thus, the upper gear can easily drive the middle gear to rotate, rolling forward and upward along the inclined plane of the lower gear with the suspension and counterweights, transferring potential energy force to the lower gear. This results in an infinite source of natural energy. The gears mentioned can also be toothed hole wheels, chain wheels, friction wheels, or magnetic wheels.

Example 3: A suspension circular body can use belt transmission to transfer potential energy force upwards. A suspension circular body transmitting upward with a belt is a suspension movable pulley, saving half the effort. When the suspension circular body uses circular top transmission, a tension wheel can be used to change the position and angle of the force point of the suspension circular body on the belt, placing the force point in the optimal position in the potential energy zone of the suspension circular body, becoming a roller transmission on an inclined plane, saving more than half the effort. The pivot point of the suspension circular body on the belt is also a point of resistance, combining both points. Rope transmission, chain and sprocket transmission, friction transmission, or magnetic transmission can also be used to transfer the potential energy force of the suspension circular body.

The examples are inexhaustible. Almost all objects are circular bodies, almost all movements can be circular motion, all capable of producing output greater than input, all capable of creating clean, cheap new energy, and all can become the circular engine of this invention.

According to the energy formula: driving force+circular body+circular motion=output greater than input=an infinitely vast source of clean, cheap new energy. Driving an axial circular body, suspension circular body, counterweight circular body, or external force circular body, positioned on a reasonable pivot with a driving force, can generate potential energy force far exceeding the driving force. The force required to restore this potential energy is much smaller than the potential energy force itself, achieving output greater than input, becoming an inexhaustible and immense source of power. It's truly miraculous. Circular motion and circular bodies hold many astonishing laws and energies that can help humanity gain endless new energy sources, new theories, inventions, machines, and products. Circular motion and circular bodies also contain many useful, interesting, and yet unrecognized miraculous laws, awaiting deeper exploration by mankind.

Since applying for the first Circular Laws-related patent on Aug. 25, 2006, and first disclosing Circular Laws 1-3, it has been 16 years, including the four Circular Laws disclosed in this application, totaling ten Circular Laws. Many more Circular Laws remain undisclosed. More exciting content is yet to come. I hope that the Patent Office gives me the opportunity to disclose and apply them sooner to benefit the world.

Fact 1: The focus of this application is on the correctness of the Circular Laws. It only takes one sentence, one fact, to prove that the Circular Laws are correct and Newton's law that ‘the greater the mass, the greater the inertia’ is wrong. That sentence is from the First Law of Circular Motion, stating ‘the force to overcome its static inertia is greater than zero.’ This is the foundation and starting point of the Circular Laws. No one can deny this fact.

Fact 2: The force required to restore potential energy in a cylindrical body rolling on an inclined plane of about 5 degrees can be much smaller than the gravitational force of the cylindrical body. Using devices like levers, the gravitational force and rolling potential energy force of this cylindrical body can be transformed into applied force, which is far greater than the force needed to restore its potential energy. This fact alone proves that output is greater than input; it also proves that the law of conservation of energy is incorrect in circular motion. These two undeniable facts validate the Circular Laws.

The above facts represent the true laws of nature, while Newton's laws and the law of conservation of energy, among other traditional theories, are incorrect in circular motion, not natural laws, not factual. Therefore, these incorrect traditional theories cannot be used to test Circular Laws and inventions that oppose them, as it would violate the principles of seeking truth from facts and the principle that practice is the sole criterion for testing truth.

The Circular Laws state that facts are sufficient to prove that Newton's laws, the law of conservation of energy, and almost all scientific theories involving mass M are incorrect in circular motion. The Patent Office claims that the Circular Laws contradict Newton's laws and the law of conservation of energy. For 16 years, this has been their stance, without providing factual or legal basis, truly lacking persuasiveness.

According to the principles and embodiments of the circular engine disclosed in this application's specification and accompanying drawings, it is possible to manufacture a circular engine that achieves output greater than input, creating vast new energy. Therefore, this application has immense practical value and utility.

Comparing today's Earth environment to that of thirty years ago starkly reveals the alarming and rapid deterioration of humanity's living environment! The current collapse is still in its quantitative phase, but future collapses could escalate geometrically, leaving us no time to react. The inventor's Circular Laws and circular engine can provide an abundant supply of clean, cheap energy, thereby saving the Earth's environment and alleviating the human crisis.

The above-mentioned Circular Laws and technical background can be used to explain and support the claims of this application. The invention will further elaborate on the technical background in the following sections.

III: Content of the Invention: The objective of this invention is to provide a zero-consumption, zero-pollution circular engine. The specific content is as follows:

1. An engine characterized by a driving force that causes at least one circular body to undergo circular motion, outputting the potential energy force of the circular body. The ‘driving force’ is the power driving the circular body; the ‘circular body’ is an object undergoing circular motion; the ‘potential energy force’ is the power generated by the circular body in motion; the potential energy force is greater than the driving force; or, the potential energy force is at least 1 time, or 2 times, or 3 times greater than the driving force.

2. The engine, or the driving force, or the circular body, or the circular motion, or the potential energy force, is characterized by one of the following:

2.1. The circular body has an axis, mounted on a base or suspension; or, the axis includes a central axis or an offset axis or a combination of both; the central axis refers to the axis at the circle's center, including gear shafts or pulley shafts or sprocket shafts; the offset axis refers to an axis outside the circle's center, including eccentric shafts; a combination of central and offset axes refers to a circular body having both; or, there is a gap and/or elasticity between the shaft and axle hole, allowing the circular body to move slightly in relation to the fixed axle hole; or,

2.2. The circular body has a reasonable pivot point; or, in motion, the gravitational forces on either side of the circular body's gravity profile are equal or nearly equal, the force to overcome its static inertia is zero or close to zero; or, in motion, the power arm is longer than the resistance arm; or, at the reasonable pivot point, the lever arm is longest, generating the maximum torque; or,

2.3. The circular body is mounted on a suspension, which is a mechanism for installing the circular body, movably connected to the base: the suspension can be flat, grid-like, frame-like, tubular, or rod-like in appearance; or, the suspension has elasticity: this elasticity includes pneumatic or hydraulic elasticity; or, there is a gap and/or elasticity between the suspension and the base; or, the circular body in motion can move slightly forward, upward, backward, and downward within a certain range relative to the suspension and base: or, there are upper stops and/or lower pivot points and/or limit springs that restrict the range of movement of the circular body and/or suspension; or, the suspension is equipped with counterweights and/or external forces; or, the suspension includes cantilevers, diagonal frames, vertical frames, booms, upper seats, or sedan bars; or, the circular body can move relative to the suspension; or,

2.4. The circular body is a drum 40 mounted on a suspension; or, there is a gap or elasticity or a movable connection between both ends of the drum 40 and the base 43; or, there is a gap or elasticity or a movable connection between the bearing seat at the ends of the drum 40 and the base 43; or, the drum 40 is located above or near the vertical centerline above the pivot wheel 41; or, the pivot wheel 41 is mounted on the base or on the ground foundation, axially aligned with the drum 40, rotating together with the drum 40; or, there is one or more bases 43 located on either side or around the drum 40; or, there are auxiliary wheels 42 mounted on the base 43; or, one or more auxiliary wheels 42 are located around, below, near, or below the horizontal centerline of the drum 40, or near the position of the pivot wheel 41; or, a driving wheel 44 is mounted on the base 43, driving the drum 40 from the top; or, the suspension is movably connected to the base 43; or, the driving wheel 44 is mounted on the suspension, with the suspension equipped with counterweights and/or external forces, mounted on the base 43 or ground foundation; or, the pivot wheel 41 is located below or near the vertical centerline below the drum 40; or, the pivot wheel 41 is located outside the vertical centerline below the drum 40, deviating 5 millimeters or more, or 10 millimeters or more, or 15 millimeters or more from the vertical centerline; or, the drum 40 is located above the vertical centerline above the pivot wheel 41, deviating 5 millimeters or more, or 10 millimeters or more, or 15 millimeters or more from the vertical centerline; or, the gravitational forces on either side of the gravity profile of the drum 40 are equal or nearly equal or unequal; or, the gravitational force in front of the moving drum 40 is greater than the force behind it, or the gravitational force in front of the moving drum 40 is less than the force behind it; or, multiple pivot wheels 41 are distributed in the direction of the drum 40; or, multiple bases 43 are distributed in the direction of the drum 40; or, there is a limiting device for the drum 40 on the base 43; or, the driving force transmits the drum 40 from the top, circular top, or around; or, the weight of the drum 40 mainly falls on the pivot wheel 41; or, the auxiliary wheel 42 assists the pivot wheel 41 in bearing weight and/or limiting the drum 40; or, the pivot wheel 41 is a gear, friction wheel, toothed hole wheel, magnetic wheel, or chain wheel; or, the drum 40 is a ball mill, dryer, or mixer drum; or, the drum of the ball mill, dryer, or mixer is located on the suspension and/or above the pivot wheel 41, equipped with a power generation device; or, the axle of the pivot wheel 41 has a pulley, friction wheel, gear, or coupling, driving a generator to produce electricity; or, the drum 40 is equipped with gears, pulleys, chains, sprockets, or friction wheels, driving a generator to produce electricity; or,

2.5. The circular body is equipped with counterweights; or, the axis of the circular body or the suspension mounting the circular body has counterweights; or, the counterweights include dynamic and static counterweights, movable and fixed counterweights: dynamic counterweights move with the circular body: static counterweights do not move with the circular body: movable counterweights are movably connected to the circular body: fixed counterweights are fixed to the circular body or related devices; or, the counterweights are hung on the circular body, its axis, or the suspension; or, the hanging counterweights are connected to the circular body, its axis, or the suspension using ropes and/or connecting rods and/or booms: or, counterweights are placed in the downward forward direction of the circular body's motion, including hanging counterweights; or,

2.6. The circular body is equipped with external forces; or, the external force works together with the driving force on the circular body: the external forces include tension and/or pressure and/or magnetic force and/or elastic force: the external forces are set on the circular body, its axis, or related devices of the circular body: the external forces can rotate with the circular body or not rotate with it; or, the circular body is equipped with both counterweights and external forces; or,

2.7. The circular body is cylindrical, disc-shaped, ring-shaped, disk-shaped, bowl-shaped, tube-shaped, or wheel-like: it has an input structure to receive driving force and an output structure to output the potential energy force of the circular body; or, it has a limiting structure to limit the circular body; or, the input structure includes an input shaft 19 or gears 9 or 10: the output structure includes an output shaft 18 or gears 9 or 10 or central axis 12: the limiting structure includes a limiting shaft 16 or central axis 12 or gears 9 or 10: or,

2.8. The circular body has a large wheel structure, with small wheels inside it that actively interact; or,

2.9. The circular body has elasticity; or, the elasticity comes from elastic materials, springs, or/and elastic devices; or, the elastic circular body produces regular vibrations; or, there are vibration reduction devices or/and limiting devices that work in conjunction with the elastic circular body; or, there is a gap and/or elasticity between the circular body's axis and the axle hole, allowing the circular body to move slightly up, down, left, and right relative to the axle hole; or, 2.10. The circular body is a magnetic flywheel or equipped with a magnetic device; or, circular bodies with magnetic devices receive magnetic drive, assisting the driving force or acting as the driving force; or, there is a magnetic circular body between the driving force and the energy user; or, the magnetic circular body is mounted on the shaft of an electric motor, generator, pulley, or gear; or, the magnetic circular body is mounted on the base and/or suspension; or, one or more well-known electromagnets or magnets are placed on both the flywheel circumference and the base, mutually inducing: when the flywheel rotates, the electromagnet on the base exerts an attractive or repulsive force on the electromagnet on the flywheel, driving the flywheel: or the magnet on the base exerts an attractive or repulsive force on the magnet on the flywheel; or, as the magnetic induction point on the flywheel passes the magnetic induction point on the base, the magnetic induction point on the base and on the flywheel generate an attractive or repulsive force, driving the flywheel; or,

2.11. The circular body has a wheel-axle structure: this wheel-axle structure includes pulleys, gears, sprockets, or flywheels; or, at least one pulley shaft and multiple pulleys of different diameters combine to form a pulley device, receiving driving force; or, multiple pulleys combine to form a pulley device; or, there is a gap or elasticity between at least one pulley shaft of the pulley device and the base; or, the pulley shaft can move slightly in relation to the base; or, the pulley shaft is equipped with counterweights and/or external forces; or,

2.12. The circular body is a crankshaft or equipped with a crankshaft: the crankshaft connects to a connecting rod, outputting the potential energy force of the circular body; or, an eccentric wheel or cam replaces the crankshaft, driving a self-resetting connecting rod; or, the connecting rod is equipped with upper and lower crankshafts; or,

2.13. The combined circular body, or multiple stamping components combined to form a circular body: or, multiple circular bodies combined, where the potential energy force of one circular body serves as the driving force for the next; or, combinations of multiple circular bodies with different structures or functions: or, multiple stamping components axially and/or radially combined to form a pulley; or, multiple stamping components axially and/or radially combined to form a gear; or, multiple stamping components axially and/or radially combined to form a circular body, which can be spherical, cylindrical, or bowl-shaped; or, a driving force propels a combined circular body with a suspension and/or counterweights and/or external forces; or, multiple magnetic flywheels combined to form a magnetic circular body; or, combinations of gears, sprockets, pulleys, chain wheels, or magnetic wheels where the potential energy force of one is the driving force for the next; or, between the driving force and the energy user, there are suspensions and/or flywheels and/or magnetic circular bodies and/or energy storage devices and/or frequency conversion devices; or, a magnetic circular body is mounted on the pulley shaft; or, the combination of circular bodies includes creative combinations or simple stacking; or, multiple circular bodies combined in a horizontal arrangement or vertically, radially, and/or axially; or, multiple circular bodies 8 and/or circular bodies 13 and/or circular bodies 17 combined axially: the potential energy force of one is the driving force for the next: or, the circular body is composed of multiple stamping components: the gear, gear 64, is composed of 3 stamping components 66 combined axially: 4 bolts 65 fix the 3 stamping components 66 together; or, the gear is radially decomposed into multiple stamping components, combined to form a gear; or, multiple stamping components combined axially and/or radially to form a gear; or, multiple stamping components combined axially and/or radially to form a pulley; or, multiple stamping components combined axially and/or radially to form a circular body, which can be spherical, cylindrical, or bowl-shaped, with bolts fixing the stamping components together; or, multiple circular bodies combined, where the potential energy force of one is the driving force for the next; or, multiple engines combined, where the potential energy force of one is the driving force for the next; or, the combination includes horizontal, vertical, radial, and/or axial arrangements; or, multiple circular bodies 8 and/or circular bodies 13 combined axially; or,

2.14. The circular body is a cylinder, mounted on a base or suspension, with one or more protrusions on its circumferential surface: these protrusions include raised points and/or ribs and/or serrations and/or wheels: the serrations refer to sawtooth-like protrusions: the wheels can roll and are mounted on the cylinder's surface: the driving force propels the cylinder in reciprocating, rolling, or rotating motion, with the protrusions transferring pressure to connecting rods, levers, or transmission bars with an automatic repositioning feature, outputting the cylinder's potential energy force; or, the automatic repositioning includes springs on the connecting rod, lever, or transmission bar; or, the cylinder mounted on the suspension, driven in reciprocating and/or rotating and/or rolling motion by the driving force, transforms the cylinder's gravity and torque and/or counterweights or external forces mounted on the cylinder into externally outputted circular body power; or, around the cylinder, there are elastic devices for positioning and/or vibration damping and/or force augmentation, these elastic devices include elastic materials and/or springs and/or pneumatic or hydraulic devices: in the potential energy zone of the cylinder, there is a lever device that receives the drive from the protrusions, outputting the cylinder's power; or, the lever device is a connecting rod crankshaft device, the connecting rod receiving the drive from the protrusions, outputting the cylinder's power; or, the lever device is a chain and sprocket device, the chain receiving the drive from the protrusions, outputting the cylinder's power; or, the lever device is a fluid pressure device, with a connecting rod piston receiving the drive from the protrusions, outputting the cylinder's power; or, the cylinder's power, which is the cylinder's potential energy force, includes the cylinder's gravity and torque or external forces mounted on the cylinder; or, the reciprocating motion includes a reciprocating motion device, this device includes a one-way wheel, which only accepts transmission in one direction, such as a ratchet or one-way bearing or stop wheel, with the one-way wheel only accepting transmission from the driving force in one direction, freewheeling in reverse; or, the stop wheel refers to a wheel with serrations at the rim, used in conjunction with an elastic stop bar, the stop bar allowing the stop wheel to rotate in only one direction; the stop bar is an elastic, automatically repositioning rod-like object; or, the stop wheel uses a well-known stop structure from cable winding turntables on ships; or, the height of the protrusions determines the working stroke; or, the cylindrical body can also be a sphere, hexagon, octagon, or disc; or, the circular body is an eccentric wheel or cam, mounted on the suspension, possibly with counterweights and/or external forces, transferring pressure to automatically repositioning connecting rods, levers, or transmission bars, outputting the cylinder's potential energy force; or, the circular body is a crankshaft, transferring pressure to automatically repositioning connecting rods, levers, or transmission bars, outputting the cylinder's potential energy force; or, the circular body is a crankshaft, with the crankshaft having a connecting rod, transferring pressure to automatically repositioning connecting rods, levers, or transmission bars, outputting the cylinder's potential energy force; or, the cylindrical body can also be a tube or drum; or,

2.15. The circular body is a sprocket, mounted on a base or suspension via a sprocket shaft. The driving force propels the sprocket, outputting its potential energy force; or, the sprocket is located beneath a generator, with the driving force moving the sprocket, which in turn drives a chain. This chain drives the generator's sprocket above to produce electricity; or, the sprocket shaft is equipped with a pulley or coupling, with the driving force moving the sprocket through the pulley or coupling, outputting the sprocket's potential energy force; or, the sprocket is a chain wheel; the chain wheel is cylindrical, disc-shaped, ring-shaped, or gear-shaped; a chain is mounted around the circumference of the chain wheel, with the chain wheel and sprocket transmitting power to each other; the driving force propels the sprocket or chain wheel, outputting power; or, the chain is mounted in a straight line on a flat board, with the driving force moving the sprocket, which in turn drives the flat board in a reciprocating motion, outputting power; or, the ‘potential energy force’ refers to the total force of the sprocket's motion, including the driving force, the gravity of the sprocket and/or torque, and/or magnetic or/and elastic forces mounted on the sprocket and suspension; the ‘gravity’ includes the sprocket's own weight or/and weights mounted on the sprocket; the ‘torque’ includes the motion torque of the sprocket and the torsional force of its material; the ‘magnetic force’ includes the attractive or repulsive force of electromagnets or magnets; the ‘electromagnetic force’ includes the attractive or repulsive force of electromagnets; the ‘elastic force’ includes the elasticity of elastic materials and/or the force of springs and/or the force of elastic devices; or,

2.16. The circular body is Circular Body 8, an internal gear with multiple gears 9 on its inner periphery; Gear 9 is connected to the base, driving force, energy user, or transmission shaft via an axis; Gear 9 can receive transmission from the driving force or Circular Body 8, or drive Circular Body 8 and/or limit Circular Body 8; the driving force propels Circular Body 8, driving Gear 9 to output power; or, the driving force drives Gear 9, which in turn drives Circular Body 8, propelling another Gear 9 to output power; or, Circular Body 8 is an internal gear with external teeth, having multiple gears 9 and/or gears 10 on both its inner and outer periphery; Gears 9 and/or 10 are connected to the base, driving force, energy user, or transmission shaft via an axis; Gears 9 and/or 10 can receive transmission from the driving force or Circular Body 8, or drive Circular Body 8 and/or limit Circular Body 8; the driving force drives Circular Body 8, propelling Gears 9 and/or 10 to output power; or, both the inner and outer periphery of Circular Body 8 have teeth; or, one or more gears 9 and/or 10 are mounted on the inner and/or outer periphery of Circular Body 8; or, the driving force drives a Gear 9 or 10, which in turn drives Circular Body 8, propelling another or multiple gears 9 and/or 10 to output power; or, there is a gap and/or elasticity between Circular Body 8 and Gears 9 and/or 10; or, Circular Body 8 can move slightly up, down, left, and right relative to Gears 9 and/or 10; or, Circular Body 8 and/or Gears 9 and/or 10 are mounted on a suspension; or, Circular Body 8 is an outer ring, rotating around Gear 9, with an inner ring gear 11. Gear 9 positioned between the inner and outer rings; Inner ring gear 11 is mounted with a central axis 12, one end of central axis 12 connected to the inner ring gear 11, the other end connected to the energy user; the driving force propels Circular Body 8 or Gear 9 or 10, driving central axis 12 to output power; or, Gears 9 and/or 10 can change their position on Circular Body 8; or, the transmission between Circular Body 8 and Gears 9, 10 uses friction, toothed hole, chain wheel, or magnetic wheel transmission; or, by installing chains on the inner and outer periphery of Circular Body 8, it can become a chain wheel, replacing gears; or, the magnetic wheel includes magnetic flywheels; or, multiple Circular Bodies 8 and Gears 9 and/or 10 are combined axially, with the potential energy force of one serving as the driving force for the next; or,

2.17. The circular body referred to is Circular Body 17, which is bowl-shaped. Circular Body 17 has a limiting shaft 16 on its inner periphery, fixedly connected to the base 21; Limiting Shaft 16 can limit Circular Body 17; Limiting Shaft 16 is equipped with a movable friction wheel; Output Shaft 18 has a fixed friction wheel and is connected to the energy user; Input Shaft 19 has a fixed friction wheel and is connected to the driving force, with all three shafts collectively positioning Circular Body 17. The driving force drives Input Shaft 19, whose friction wheel rubs against the inner periphery of Circular Body 17, causing it to rotate relative to Base 21; the inner periphery of Circular Body 17 drives the friction wheels on Limiting Shaft 16 and Output Shaft 18, causing the friction wheel on Limiting Shaft 16 to idle, while Output Shaft 18 drives the energy user, outputting power; or, Circular Body 17 has one or more limiting shafts and/or one or more input shafts and/or one or more output shafts on its inner and/or outer periphery; or, Limiting Shaft 16 and/or Output Shaft 18 and/or Input Shaft 19 are elastic; or, there is a gap and/or elasticity between Circular Body 17 and Limiting Shaft 16 and/or Output Shaft 18 and/or Input Shaft 19; the elasticity comes from elastic materials, springs, or elastic devices; or, Circular Body 17 can move slightly up, down, left, and right; or, the center of Circular Body 17 has a central shaft 20, movably connected to Circular Body 17 and Base 21, with Central Shaft 20 and Limiting Shaft 16 together positioning Circular Body 17; or, there is a gap and/or elasticity between Circular Body 17 and Central Shaft 20; or, Circular Body 17 can move slightly up, down, left, and right relative to Central Shaft 20; or, Central Shaft 20 is fixedly connected to Circular Body 17 and the energy user, with the driving force driving Input Shaft 19 to propel Circular Body 17, outputting power; or, the positions of the limiting shaft and/or output shaft and/or input shaft can be changed on Circular Body 17; or, the friction transmission can also be gear transmission, magnetic transmission, toothed hole wheel transmission, or chain wheel transmission; or, chains are mounted on the inner and/or outer periphery of Circular Body 17 to become a chain wheel, cooperating with multiple sprockets for transmission; or,

2.18. The circular body referred to is Circular Body 13, which can be cylindrical, ring-shaped, annular, or tubular; it has multiple small wheels 15 lodged in one or both sides of grooves on Circular Body 13, serving as limiters and/or for transmission. Small wheels 15 frictionally transmit with Circular Body 13; they are connected to the base, driving force, and/or energy user. The driving force moves Circular Body 13, driving multiple small wheels 15 to rotate, with at least one small wheel connected to the energy user, outputting power; or, the driving force propels at least one small wheel 15, which in turn drives Circular Body 13, moving other small wheels 15, with at least one small wheel 15 connected to the energy user, outputting power; or, Circular Body 13's inner and/or outer periphery has one or more small wheels 15; or, the driving force employs magnetic, gear, or chain wheel transmission; or, the driving force moves at least one small wheel 15 or Circular Body 13, with Circular Body 13 driving another or more small wheels 15 to rotate, and at least one small wheel 15 connected to the energy user, outputting power; or, a central shaft 14 passes through the center axis hole of Circular Body 13, mounted on a suspension or base, providing limitation and support for Circular Body 13; Circular Body 13 rotates around Central Shaft 14; the driving force moves at least one small wheel 15, with at least one small wheel 15 connected to the energy user's shaft, outputting power; or, Central Shaft 14 is fixedly connected to Circular Body 13 and the energy user, with the driving force moving small wheel 15, outputting power; or, Circular Body 13 is fixedly mounted on a suspension or base, with a gap or elasticity between it and Central Shaft 14; or, Central Shaft 14 can move slightly up, down, left, and right in the center axis hole of Circular Body 13; or, the position of small wheel 15 can be changed on Circular Body 13; or, Circular Body 13 or small wheel 15 is mounted on a suspension; or,

2.19. The circular body is Gear, with Upper Gear 25 mounted on Sedan Bar 23 and Middle Gear 26 mounted on Sedan Bar 28. The driving force propels Upper Gear 25, driving Middle Gear 26 and Lower Gear 27, outputting the potential energy force of Middle Gear 26; or, Upper Gear 25 and/or Sedan Bar 23 have counterweights and/or external forces; or, Middle Gear 26 and/or Sedan Bar 28 have counterweights and/or external forces; or, the external forces include pressure and/or tension and/or elastic force and/or magnetic force; or, Upper Gear 25 and/or Middle Gear 26 are mounted on a suspension, movably connected to the base; or, Middle Gear 26 is located near the vertical centerline above Lower Gear 27; or, the meshing point between Middle Gear 26 and Lower Gear 27 serves as the pivot point when Middle Gear 26 moves on Lower Gear 27; or, Upper Gear 25 is located near the vertical centerline above Middle Gear 26; or, the meshing point between Upper Gear 25 and Middle Gear 26 serves as the pivot point when Upper Gear 25 moves on Middle Gear 26; or, Middle Gear 26 with Sedan Bar 28 rolls up the inclined surface of Lower Gear 27; or, Upper Gear 25 with Sedan Bar 23 rolls up the inclined surface of Middle Gear 26; or, Middle Gear 26 in rotation creates slight forward, upward, backward, and downward movements; or, Upper Gear 25 in rotation creates slight forward, upward, backward, and downward movements; or, a gear shaft has two or more Upper Gears 25 or Middle Gears 26 or Lower Gears 27, i.e., multiple gears arranged side by side on one gear shaft; or, Middle Gear 26 is equipped with a suspension and/or counterweights and/or external forces; the driving force propels Middle Gear 26, transforming its potential energy force into output power; or, Middle Gear Shaft 31 has a driven gear or driven pulley or coupling, directly receiving transmission from the driving force; or, the output power is greater than the driving force; or, the potential energy force refers to the force generated by Middle Gear 26 in motion; or, the potential energy force includes the potential force and/or gravity and/or torque and/or tension and/or pressure and/or external forces mounted on Middle Gear 26; the gravity includes the weight of Middle Gear 26 itself, the suspension, and weights mounted on Middle Gear 26; the torque includes the motion torque generated by Middle Gear 26 and the elastic torque from the material of Middle Gear 26 itself; the external force refers to magnetic force and/or elastic force and/or tension and/or pressure mounted on Middle Gear 26; the magnetic force includes the attractive or repulsive force of electromagnets or magnets; the electromagnetic force includes the attractive or repulsive force of electromagnets; the elastic force includes the elasticity of elastic materials and/or the force of springs and/or the force of elastic devices; or, the diameter of Upper Gear 25 is smaller than that of Middle Gear 26; or, the diameter of Middle Gear 26 is smaller than that of Lower Gear 27; or, the sedan bar is equipped with a sleeve, which is a Vertical Sleeve 61 with perpendicular holes 62 and 63; or, the gears are toothed hole wheels, friction wheels, chain wheels, or magnetic wheels; or,

2.20. The circular body in question is a pulley, installed on the shaft of an electric motor, a generator, or a pulley shaft. Alternatively, a pulley apparatus may consist of a base and at least one pulley shaft mounted on it, along with driven and driving pulleys on the same shaft. Multiple pulleys of varying diameters, in combination with a high-speed electric motor and a low-speed generator, enable the high-speed motor to drive the pulleys, which in turn power the low-speed generator, producing energy output that exceeds the input. In one configuration, a high-speed electric motor is combined with a pulley apparatus and a low-speed generator to generate electricity, where the output energy exceeds the input. In another scenario, the driving force moves a high-speed electric motor, which then drives a low-speed generator, resulting in an output that is three times or more than the input energy. In a similar setup, an electric motor combined with a pulley apparatus drives a low-speed generator, again tripling the energy output compared to the input. The driving pulley on the high-speed electric motor powers the driven and driving pulleys on the pulley shaft, with the driving pulley then driving the generator's pulley to generate electricity, achieving an output that is three times or more than the input. Additionally, the electric motor can be combined with multiple pulley apparatuses and a low-speed generator for power generation. Multiple pulley apparatuses can be arranged horizontally, vertically, or in a stacked configuration with the electric motor, which drives the pulleys on these apparatuses to generate power. The diameter of the pulley on the high-speed electric motor's shaft is smaller than that of the driven pulley. The driven pulley refers to the pulley that receives transmission from another, whereas the driving pulley transmits to another. The diameter of the driving pulley is smaller than that of the generator's pulley. The pulleys can be installed on a suspension system below the generator, with belts transmitting power to the generator's pulley for electricity generation. The pulleys can also be mounted on a suspension system beneath a low-speed generator, with weights or external forces on the suspension driving the generator above. The electric motor's shaft can have a pulley mounted on a suspension, driving the generator's pulley. The pulley shaft is installed on a suspension, possibly with weights or external forces. The transmission direction of the driving pulley is above the horizontal line. Two pulleys are arranged in an upward slant, with the driven pulley positioned above or higher than the driving pulley.

Flywheels or magnetic flywheels are installed on the shafts of electric motors, pulley shafts, or generators. Additionally, the pulleys on the pulley shaft, electric motor shaft, or generator shaft may incorporate a flywheel structure, serving a dual purpose of energy storage. The diameter of the pulley on the high-speed electric motor's shaft is larger than that on the low-speed generator's shaft, potentially being twice as large or more. Similarly, the pulley on the high-speed motor's shaft is larger in diameter than the driven pulley, possibly double or more. The driving pulley on the pulley shaft has a diameter greater than the pulley on the low-speed generator's shaft, again potentially being twice as large or more. The diameter of the driving pulley is larger than that of the driven pulley, possibly being double or more. The diameter of the driving pulley on a single pulley shaft is larger than that of the driven pulley, potentially being twice as large or more. The rotational speed of the high-speed electric motor is 600 RPM or more, reaching levels of 900, 1400, 2000, or even 2800 RPM. Conversely, the low-speed generator operates at speeds below 600 RPM, such as 300, 200, 100, 50, or even 30 RPM. The power output of the electric motor is less than twice, three times, or more than the generator's power output, meaning the output exceeds the input by at least double or triple. The pulleys are mounted on a suspension, with the electric motor and generator operating at similar or identical speeds. At least one pulley in the pulley apparatus is a magnetic circular body. The pulleys themselves are imbued with magnetic properties, functioning as magnetic circular bodies. There is a gap or elasticity between the pulley shaft and the shaft hole, allowing the pulley shaft to move slightly in all directions relative to the shaft hole, and vice versa. The belts used are synchronous belts.

2.21. The magnetic circular body is a magnetic flywheel; Magnetic Flywheel 52 has multiple magnetic induction points 53; the base 54 of Magnetic Flywheel 52 has magnetic induction points 55 corresponding to the induction points 53 on the flywheel; or, around the circumference of Flywheel 52 and on Base 54, there are one or more electromagnets or magnetic induction devices, i.e., the magnetic induction points, which mutually induce. When a magnetic induction point 53 on Flywheel 52 passes a magnetic induction point 55 on Base 54, the induction point 55 on Base 54, controlled by well-known technology including relays or commutators, generates attraction or repulsion on the induction point 53 on Flywheel 52, driving the flywheel. Similar to the stator and rotor in a well-known electric motor, the attraction and repulsion forces drive the rotor. Flywheel 52 acts like the rotor of an electric motor, and Base 54 is akin to the stator of an electric motor; or, a magnetic circular body is mounted on the shaft of an electric motor, pulley, gear, or generator; or, there is a flywheel or magnetic flywheel mounted between the driving force and the energy user; or, the circular body shaft is equipped with a flywheel or magnetic flywheel; or, the circular body is magnetic, accepting magnetic drive, assisting the driving force, or acting as the driving force; or, the magnetic circular body is mounted on a base or suspension; or,

2.22. The circular body is a chain wheel; the chain wheel can be cylindrical, disc-shaped, ring-shaped, or gear-shaped. The chain wheel is constructed with two clamping plates 56 holding a chain 59; multiple pins 57 fix the chain 59 between the two clamping plates 56; multiple bolts 60 connect the two clamping plates 56 together. The chain wheel transmits with a sprocket. Or, the chain is linearly mounted on a flat plate, the driving force drives the sprocket, moving the chain and flat plate reciprocally, outputting power; or,

2.23. The circular body is mounted on a sedan bar, which has a vertical sleeve 61 with mutually perpendicular vertical holes 62, 63. Sedan Bars 23 or 28 are made of tubes, with vertical sleeves 61 at both ends, sliding back and forth in vertical hole 62. Vertical hole 63 is mounted on a vertical hole shaft on the base, allowing up and down movement. The circular body with a sedan bar can move forward, backward, up, and down relative to the base. The vertical sleeve 61 can also act as a sliding sleeve for a suspension; or,

2.24. The specified driving force propels the circular body into the described circular motion, transforming the potential energy force of the circular body into output power. The driving force includes well-known electric power and/or battery power, magnetic force, human power, animal power, hydraulic power, wind power, or spring power. Or, the driving force could be an electric motor, internal combustion engine, steam engine, hydrogen engine, magnetic engine, pneumatic engine, or spring device. The driving force comes from an electric motor, internal combustion engine, steam engine, hydrogen engine, magnetic engine, pneumatic engine, or a spring. The driving force uses well-known shaft transmission, friction transmission, gear transmission, pulley transmission, universal joint transmission, magnetic transmission, or chain wheel transmission as per this invention. The ‘driving force’ refers to the power that drives the circular body. The ‘potential energy force’ of the circular body is synonymous with the ‘circular body power’. The ‘acting force’ can be the driving force; or,

2.25. The ‘circular body’ refers to objects with circular motion, including devices. The ‘object’ refers to tangible entities, including spheres, cylinders, pulleys, friction wheels, toothed hole wheels, chain wheels, flywheels, or drums. The circular body can amplify the driving force during circular motion. ‘Amplification’ means the output power is greater than the driving force. Circular motion is motion with a radius. ‘Circular motion’ refers to motion with a center and radius, including rotation, rolling, swinging, rocking, shaking, or simultaneous rotation and rolling; or,

2.26. The potential energy force is derived from the circular body's kinetic potential energy, including the potential force and/or gravity, torque, tension, pressure, and external forces mounted on the circular body generated during its motion. The gravity includes the weight of the circular body itself, the suspension, and any additional weights mounted on the circular body. The torque includes the kinetic torque generated by the circular body during motion and the elastic torque produced by the material of the circular body. The external force refers to magnetic force and/or elastic force, tension, and pressure mounted on the circular body. The magnetic force includes electromagnetic force or magnetism, and the elastic force includes the elasticity of materials, the force of springs, or the force of elastic devices. Or, the ‘driven pulley’ or ‘driven gear’ refers to a pulley or gear that receives transmission from another; the ‘driving pulley’ or ‘driving gear’ refers to a pulley or gear that transmits to another. Or, ‘output greater than input’ means the output energy or power exceeds the input energy or power; or,

2.27. The electric motor could also be an internal combustion engine, steam engine, hydrogen engine, magnetic engine, pneumatic engine, or a spring device. Or, ‘multiple’ refers to two or more. Or, a tension wheel is set between the pulleys. Or, a base contains multiple pulley shafts and combinations of pulleys. Or, the engine is used for oilfield pumping units, dryers, mixers, or ball mills. Or, multiple pulleys are on a pulley shaft mounted on a suspension; the driving force powers the pulleys on the suspension, outputting power. Or, between two pulleys on a belt, there is at least one pulley with a suspension participating in the transmission. Or, the rotational speeds of the electric motor and generator are the same or similar. Or, the circular body is mounted on a suspension with counterweights and/or external forces; the suspension is movably connected to the base, and an electric motor drives the circular body, outputting potential energy force to a generator. Or, the ‘energy user’ refers to objects utilizing energy, such as lathes, water pumps, generators, ball mills, couplings, or drive shafts. Or, ‘magnetic force’ includes the known attraction and repulsion forces of electromagnets and magnets. The magnetic transmission structure includes the magnetic transmission structure of an electric motor. Or, the pulley device includes at least one base, at least one pulley shaft mounted on the base, and a driven pulley and driving pulley mounted on the same pulley shaft. Or, ‘mounting’ includes well-known bearing mounting, bushing mounting, bearing cup mounting, or component mounting. Bearing, bushing, or bearing cup mounting refers to mounting the shaft of a component or mechanism with bearings, bushings, or bearing cups on a base, suspension, or energy user.

The ‘shaft’ includes gear shafts, pulley shafts, sprocket shafts. A ‘bushing’ refers to a sleeve on a shaft, where the shaft slides or rotates within the sleeve. A ‘bearing cup’ refers to a steel cup on a shaft with steel balls, where the shaft rotates within the steel balls. Or, there is a gap and/or elasticity between the circular body shaft and the shaft hole, allowing the circular body shaft to move slightly up, down, left, and right relative to the shaft hole. The circular body shaft includes pulley shafts, gear shafts, sprocket shafts, or chain wheel shafts. Or, the ‘elasticity’ comes from elastic materials, springs, or elastic devices. Or, the gap and/or elasticity allow for slight up, down, left, and right movement between components, which can also be achieved by other methods or devices. Or, ‘automatic repositioning’ includes setting springs on connecting rods, levers, or transmission bars.

3. Manufacturing Method of the Engine: This method is characterized by a driving force propelling at least one circular body into circular motion, outputting the potential energy force of the circular body. The driving force is the power that drives the circular body. The circular body is an object that undergoes circular motion. The potential energy force is the power produced by the circular body during its motion and is greater than the driving force; or, the potential energy force is more than one, two, or three times the driving force.

3.1. The engine is used in mobile phones, watches, airplanes, generators, or human body devices. Or, the engine replaces batteries, internal combustion engines, steam engines, hydro power, wind power, solar power, or fossil fuels. Or, the engine is used in spacecraft or on other planets.

Advantages of this invention: On one hand, there is a significant energy crisis, while on the other, immense natural energy resources remain unrecognized. This invention contributes by providing new methods and devices to harness the solid potential energy of circular bodies. Axial circular bodies and suspension circular bodies allow for stable operation and effective power transmission. Counterweight circular bodies and external force circular bodies can infinitely increase potential energy force. Driving force+circular body+circular motion=output greater than input=infinite energy=perpetual motion machine. This realizes the dream of a perpetual motion machine, overcoming the prejudice that output cannot exceed input in known technology. Zero consumption, zero emissions, zero pollution, providing humanity with ample clean and cheap new energy. It avoids the limitations of fossil fuels being finite, costly, and polluting, potentially replacing them as the main energy source for humanity. It helps humanity overcome energy and environmental crises and achieve carbon emission goals. Natural energy is omnipresent, inexhaustible, and readily available, more convenient and cost-effective than traditional energy sources. It's easy to make something simple complex, but not easy to make something complex simple. This invention is simpler and more practical than known technology. With sufficient clean and cheap energy, everything is attainable. Over 90% of human energy and products will be optimized and advanced due to this invention.

### IV: Diagrams and Examples: The invention is further explained below in conjunction with the diagrams and examples.

FIGS. 1-12 are schematic diagrams of axial circular bodies: FIGS. 13-16 are diagrams of suspension and upper, middle, and lower gear structures:

FIGS. 17-18 are schematic diagrams of drum circular bodies: FIGS. 19-24 are diagrams of three types of protrusion structures:

FIGS. 25-26 are schematic diagrams of magnetic flywheels: FIGS. 27-28 are diagrams of chain wheel structures:

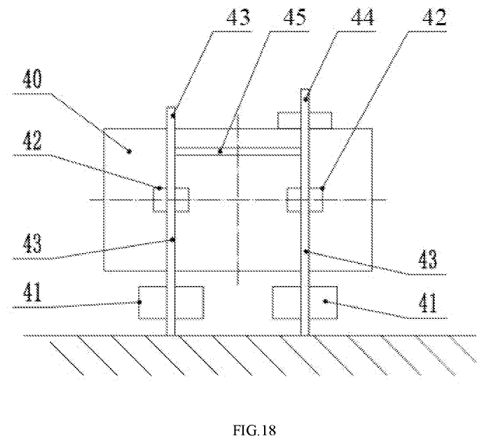

FIGS. 29-30 are diagrams of a vertical sleeve structure: FIGS. 31-32 are diagrams of stamped gear structures.

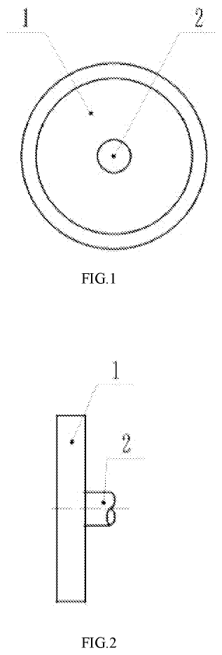

FIG. 1 is the right view of FIG. 2. The gear 1 has a central axis, representing an axial circular body, with 2 as the axis. Gears, wheels, and pulleys with an axis at their center can all be axial circular bodies as described in this invention. The middle gear 26 in this invention is an example of an axial circular body. Axial circular bodies with a central axis operate smoothly and it's easy to attach suspensions, counterweights, or external forces.

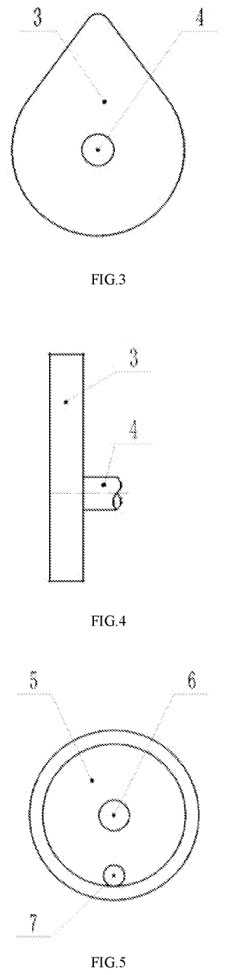

FIG. 3 is the right view of FIG. 4, showing a known cam as an axial circular body, with the cam 3 centered on the axis 4. Driven by a driving force, the cam mounted on a suspension presses down an automatically repositioning elastic lever or pedal in an up-and-down reciprocating motion, capable of outputting potential energy force. The pedal is a flat object. Cam 3 is a gear with one tooth. Cam 3 can be modified to have multiple teeth, becoming protrusions, moving on a lever with a suspension like a gear.

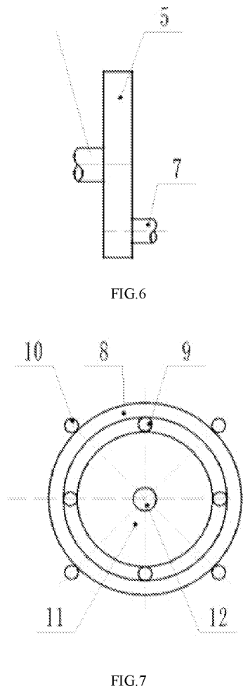

FIG. 5 is the right view of FIG. 6, where an eccentric wheel can be an eccentric axial circular body. 5 is the wheel, 6 is the central shaft, and 7 is the eccentric shaft. A driving force can power an eccentric wheel mounted on a suspension, driving another circular body in a reciprocating motion through a connecting rod, outputting potential energy force. A driving force can also power an eccentric wheel mounted on a suspension to press down an automatically repositioning elastic lever or pedal in an up-and-down reciprocating motion.

FIG. 7 is the right view of FIG. 8. Circular body 8 is an internal gear with 4 gears 9 on its inner periphery: gears 9 have axles connected to the base or driving force or energy user or transmission shaft. Gears 9 can receive driving force or drive from circular body 8, or transmit or limit circular body 8: the driving force drives circular body 8 to power gears 9 to output force. Alternatively, gears 9 and/or gears 10 have axles connected to the base or driving force or energy user or transmission shaft or transmission device: energy user refers to energy-using objects, including lathes, water pumps, generators, ball mills, couplings, or transmission shafts. The base and energy user are omitted in the figure. Gears 9 or 10 can receive driving force or drive from circular body 8, can drive or limit circular body 8. Gears 9 and 10 can have a gap and/or elasticity with circular body 8, allowing small up, down, left, and right movements relative to gears 9 and 10, with a movement range set to about one millimeter. Other methods or devices can also allow circular body 8 to move slightly relative to gears 9 and 10. The driving force drives circular body 8 via gears 9 or 10, and circular body 8 in turn drives other gears 9 and/or 10 to output force. Or, the driving force drives one of gears 9 or 10, driving circular body 8, which then drives another or multiple gears 9 or 10 to output force. Or, circular body 8 has internal and/or external teeth, with one or more gears 9 on its inner periphery and one or more gears 10 on its outer periphery. FIG. 7 shows 4 gears 10 distributed on the outer periphery of circular body 8. One or more gears 9 and/or 10 can be set on the inner and/or outer periphery of circular body 8. Or, the driving force drives one of gears 9 or 10, driving circular body 8, which then drives another or multiple gears 9 and 10, outputting force to the energy user. Or, following the structure of known bearings, an inner ring gear 11 is set, with a central shaft 12 at the center of inner ring gear 11. Gear 9 is located between inner ring gear 11 and circular body 8. Circular body 8 is similar to the outer ring of a bearing, revolving around gear 9, with an inner ring gear 11 set, gear 9 located between the inner and outer rings; or, inner ring gear 11 is installed with a central shaft 12, one end of central shaft 12 connected to inner ring gear 11, the other end to the energy user: driving force drives circular body 8 or gears 9 or 10, driving central shaft 12 to output force; or, multiple circular bodies 8 are axially combined with gears 9 and/or 10, with the potential energy force of one being the driving force of the next. Or, the transmission structure of circular body 8 and gears 9, 10 can also be known gear hole wheel transmission structure or friction wheel transmission structure or magnetic transmission structure. Or, friction wheel transmission combines with gear transmission. For example, the outer periphery of circular body 8 is friction transmission, and the inner periphery is gear transmission. Inner and outer periphery refers to the vicinity of the inner and outer edges of circular body 8. Or, gears 9 and/or 10 can change positions on circular body 8.

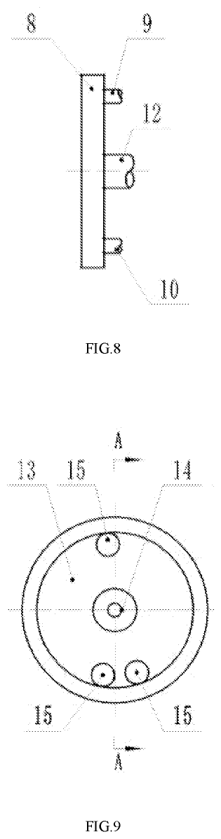

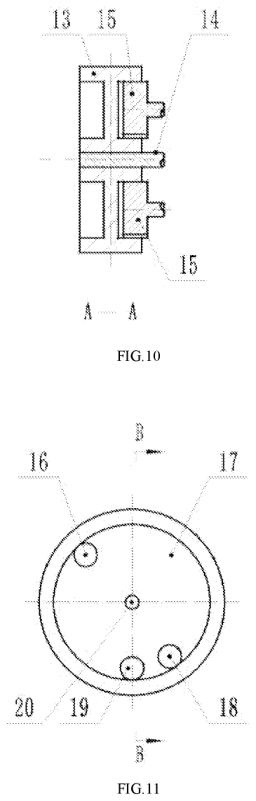

FIG. 10 is the A-A cross-sectional view of FIG. 9. The circular body 13 is shaped like a disc. Circular body 13 can also be cylindrical, ring-shaped, annular, or tubular. Three small wheels 15 are fitted into a groove on one side of circular body 13, creating a friction drive with the body. Small wheels 15 have limiting and/or driving functions and are connected to the base, suspension, driving force, or energy user: structures of the base, suspension, driving force, and energy user are omitted in the figure. The driving force powers one or more small wheels 15 to rotate, with at least one small wheel 15 connected to an energy user, outputting force; or, circular body 13 has one or more small wheels 15 on its inner or outer periphery; or, driving force uses known friction, magnetic, gear, or chain wheel transmission to drive circular body 13, which in turn drives another one or more small wheels 15, with at least one connected to an energy user, outputting force; or, driving force powers at least one small wheel 15, which drives circular body 13, and circular body 13 drives another small wheel 15, outputting force; or, a central shaft 14 passes through the central axis hole of circular body 13 and is mounted on the suspension or base, providing limitation and support to circular body 13: circular body 13 rotates around central shaft 14: driving force powers one or more small wheels 15, with at least one connected to the energy user's shaft, outputting force; or, central shaft 14 is fixedly connected to circular body 13 and the energy user, and driving force powers small wheel 15 to output force; or, circular body 13 is fixed to the suspension or base, with a gap or elasticity with central shaft 14, allowing small movements in the shaft hole: the movement range can be set to about one millimeter. Alternatively, central shaft 14 is fixed to the suspension or base, with a gap or elasticity between them, allowing circular body 13 to move slightly relative to central shaft 14. Or, small wheel 15 and central shaft 14 together limit circular body 13; or, small wheel 15 can change its position on circular body 13; or, circular body 13 or small wheel 15 is mounted on the suspension; or, known internal gear transmission, gear hole transmission, or chain wheel transmission can be used.

Various transmission structures and methods can be combined. For example, the outer periphery of circular body 13 could be friction wheel transmission, and the inner periphery gear transmission. Or conversely, the outer periphery of circular body 13 is gear transmission, and the inner periphery is friction wheel transmission.

FIG. 12 is the A-A cross-sectional view of FIG. 11. The figure omits base 21. Circular body 17 is bowl-shaped, with limiting shaft 16 fixedly connected to base 21, serving a positioning function. Limiting shaft 16 is movably connected to a friction wheel. Output shaft 18 is fixedly connected to a friction wheel and connected to an energy user. Input shaft 19 is fixedly connected to a friction wheel. The driving force powers input shaft 19, whose friction wheel rubs against the inner wall of the perimeter of circular body 17, causing it to rotate relative to base 21. The friction wheel of limiting shaft 16 and output shaft 18, which are rubbed by the inner wall of the perimeter of circular body 17, rotate accordingly; the friction wheel of limiting shaft 16 is idling. The friction wheel of output shaft 18 drives the energy user, outputting power. All friction wheels are omitted in the figure. Alternatively, the center of circular body 17 is movably connected to central shaft 20 and base 21. Bearings can be fitted to the central shaft. Central shaft 20 and limiting shaft 16 can together position circular body 17. There can be a gap or elasticity between circular body 17 and central shaft 20, allowing slight movement of circular body 17 relative to central shaft 20. The elasticity comes from elastic materials, springs, or elastic devices. Or central shaft 20 can be fixedly connected to circular body 17, replacing output shaft 18 which outputs power. The roles and/or positions of the limiting shaft, output shaft, and input shaft on circular body 17 can be changed as needed. For example, limiting shaft 16, output shaft 18, and input shaft 19 could be changed to limiting shaft 19, output shaft 16, and input shaft 18. Or, the positions of limiting shaft 16, output shaft 18, and/or input shaft 19 on the inner periphery of circular body 17 could be changed; or, the positions of limiting shaft, output shaft, and/or input shaft on the outer periphery of circular body 17 could be changed; or, one or more limiting shafts, output shafts, and/or input shafts could be placed on the inner or outer periphery of circular body 17; or, the friction wheel transmission could also be a known gear transmission, gear hole transmission, magnetic transmission, or chain wheel transmission. Placing a chain on the inner periphery of circular body 17 makes it a chain wheel, which transmits with a sprocket.

FIG. 13 is a top view of FIG. 15, omitting components such as middle gear 26, lower gear 27, and motor 33. This is a three-gear engine with upper gear 25 and pulley 34 mounted on upper gear shaft 24. Upper gear shaft 24 is mounted on carriage arm 23, which is mounted on base 22. Pulley 34 receives driving power. Four diagonal springs 35 that limit or amplify force or dampen vibrations are installed between upper gear shaft 24 and the four corners of base 22.

FIG. 14 shows a left view of the upper gear, upper gear shaft, and pulley 34 in FIG. 13, with other components omitted.

FIG. 15 illustrates that base 22 can be divided into an upper seat and a lower seat, together forming base 22. The upper seat can also serve as a type of suspension. FIG. 15 shows the dividing surface 29 between the upper and lower seats. The bottom edge of the upper seat can extend downwards, for instance, all the way to the ground. Upper gear 25, middle gear 26, and lower gear 27 are arranged vertically and transmit power sequentially. Lower gear 27 is mounted on lower gear seat 30. Motor 33 drives upper gear shaft 24 via belt 32, powering upper gear 25 which then drives middle gear 26, transferring power to lower gear 27. There are four diagonal springs 35 and down springs 36. Diagonal springs 35 do not affect the downward movement and gravity release of upper gear 25 and middle gear 26. Diagonal springs 35, having a limiting or amplifying or damping function, are installed between the upper gear shaft 24 or middle gear shaft 31 and the frame of base 22. Diagonal springs 35 and down springs 36 can be installed between the suspension and the base. Upper gear 25 is located near the vertical centerline above middle gear 26; middle gear 26 is similarly positioned above lower gear 27. Alternatively, upper gear 25 may be positioned 10 millimeters or more off the vertical centerline above middle gear 26; and middle gear 26 likewise above lower gear 27. A rational pivot point is crucial and does not necessarily need to be on or near the vertical centerline but should be determined based on specific circumstances. The meshing point between upper gear 25 and middle gear 26 serves as a pivot when upper gear 25 moves on middle gear 26. Similarly, the meshing point between middle gear 26 and lower gear 27 serves as a pivot when middle gear 26 moves on lower gear 27. Upper gear 25 drives middle gear 26 from the top; middle gear 26 drives lower gear 27 from the top. Upper gear 25 can roll upwards along the inclined surface of middle gear 26 with carriage arm 23. Middle gear 26 can similarly roll upwards along the inclined surface of lower gear 27 with carriage arm 28; upper gear 25 in rotation can produce slight up-front and down-back movements relative to middle gear 26 or the base. Middle gear 26 in rotation can similarly produce slight movements relative to lower gear 27 or the base. Iron block counterweight 38 is hung on middle gear shaft 31 with steel wire rope 37. A fixed pulley 39 changes the direction or position of the hanging counterweight. Counterweight 38 is a type of movably connected dynamic counterweight and a hanging counterweight. There can also be fixed static counterweights, which are fixedly connected to the suspension or circular body shaft. Counterweight 38, set horizontally or in the downward front direction of the circular body, does not affect the gravity release during the downward movement of the circular body. Upper gear 25, middle gear 26, and the suspension can all have counterweights and/or external forces. The potential energy force of upper gear 25 is the driving force for middle gear 26.

The force applied by the upper gear 25 to drive the middle gear 26 is significantly less than the potential energy force generated by the middle gear 26 during its motion; the potential energy force produced by the middle gear 26's weight and external forces during motion is far greater than the resistance of the lower gear 27. Driving a suspension circular body, a counterweight circular body, or an external force circular body positioned on a rational pivot can yield a potential energy force far exceeding the driving force, meaning the output exceeds the input, and the force required to restore this potential energy is significantly less than the potential energy force itself. The circular body or suspension can have springs or elastic devices for positioning, damping, or force amplification, where the elasticity includes the material elasticity of components; these elastic devices can be made of elastic materials, or be pneumatic or hydraulic devices. Ignoring the driving force, the size of the potential energy force of the middle gear 26 is determined by the counterweight and external forces on it and their pivot position on the lower gear 27. In essence, the size of the middle gear 26's potential energy force is primarily determined by the counterweight and external forces on it and their pivot position on the lower gear 27. Counterweights and external forces on the middle gear 26 can be set as needed. The counterweight and external forces on the middle gear 26, along with their pivot position, ensure that the gravitational forces on either side of the middle gear 26's gravity profile are nearly equal. Thus, the upper gear 25 can easily overcome the resistance of the middle gear 26. The resistance of the middle gear 26 includes its gravitational force and other static inertial forces. The upper gear 25 can easily drive the middle gear 26, along with the carriage and counterweight, to roll upwards along the inclined surface of the lower gear 27, transferring power to the lower gear 27 and outputting the potential energy force of the middle gear 26. Therefore, the force exerted by the upper gear 25 to drive the middle gear 26 (i.e., the force to restore the potential energy of the middle gear 26) is significantly less than the potential energy force generated by the middle gear 26 in motion. Due to the potential energy force generated by the middle gear 26's own weight, counterweight, and external forces during motion being significantly greater than the resistance of the lower gear 27, as soon as a tooth of the middle gear 26 just touches a tooth of the lower gear 27, the reaction force (resistance) of the lower gear 27 is easily overcome by the potential energy force of the middle gear 26 (i.e., pressed down). As soon as one tooth is pressed down to rotate, the next tooth engages, and the cycle repeats. The middle gear 26 continuously alternates the pivot and resistance points on the lower gear 27 in this way. Before motion, the middle gear 26 uses the meshing point as the pivot, and the carriage is the point of resistance. During motion, when one or several teeth of the middle gear 26 press down (transmit) one or several teeth of the lower gear 27, the carriage becomes the pivot, and the meshing point becomes the point of resistance. The meshing point is both a point of resistance and a pivot, coinciding at two points. During motion, the carriage and meshing point continuously exchange roles, with the meshing point being the pivot at the very moment the upper and lower teeth just touch, then becoming the point of resistance.

During transmission, as the upper and lower teeth contact and separate, the middle gear 26 exhibits minor forward, upward, backward, and downward movements between adjacent teeth, meaning the rotating middle gear 26 undergoes small-scale movement on the lower gear 27, creating a regular vibration. The amplitude of this vibration can be controlled within 1 millimeter. Damping springs and other vibration-reducing devices can be set up to prevent and minimize unnecessary vibrations. The most efficient transmission occurs when the upper gear 25 drives the middle gear 26 at its crown and the middle gear 26, in turn, drives the lower gear 27 at its crown. The force transmitted by the middle gear 26 to the lower gear 27 is significantly greater than the force transmitted by the upper gear 25 to the middle gear 26, resulting in an output that is much larger than the input. Hence, an endless supply of clean, affordable power can be achieved. Alternatively, the middle gear shaft 31 can be equipped with a driven gear, a driven pulley, or a coupling, directly receiving transmission from the driving force, eliminating the need for the upper gear 25 and its components. A driven gear refers to a gear that receives transmission. Additionally, the diameter of the upper gear 25 can be smaller than that of the middle gear 26, and the diameter of the middle gear 26 can be smaller than that of the lower gear 27. The gears mentioned can also be chain wheels, friction wheels, or chain wheels.

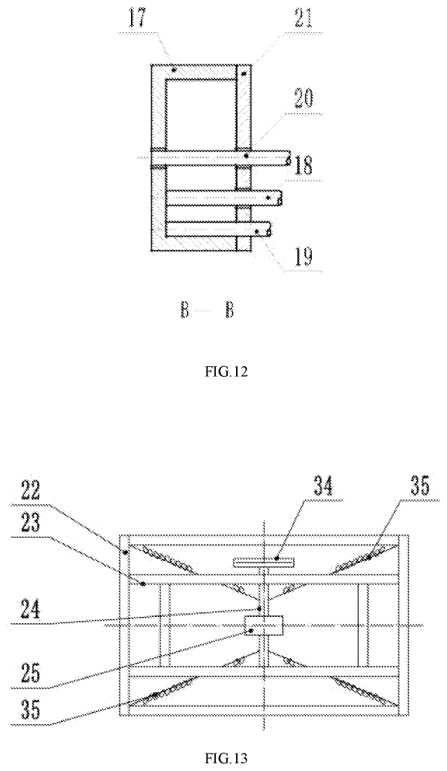

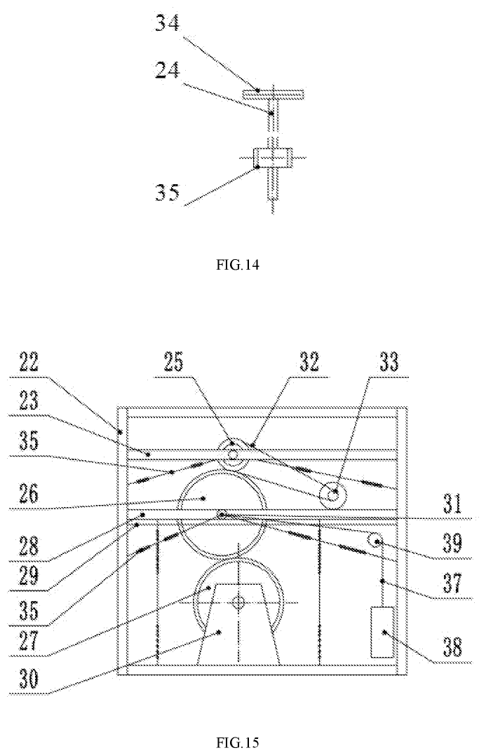

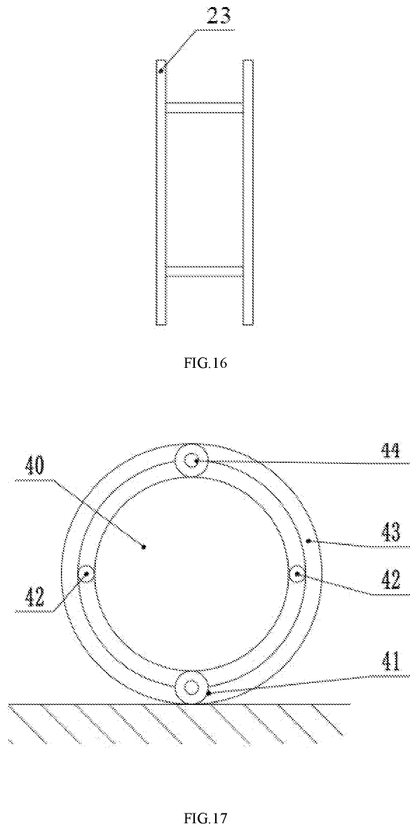

FIG. 16 illustrates a framework structure for the carriage of the upper gear 23 or the middle gear 28, formed by connecting two long and two short square tubes into a frame. The carriage 23 can also be made of round tubes, channel steel, or steel rods. It serves as a type of suspension. The shafts of the upper gear 24 or the middle gear 31 can be mounted on the carriage using conventional bearings and bearing housings. The ends of the carriage can be equipped with sliding sleeves, grooves, or vertical sleeves 61, allowing for slight forward, upward, backward, and downward movements relative to the base 22. The structure and usage method of the middle gear carriage 28 can be similar to those of the upper gear carriage 23. The suspension can have gaps or elasticity relative to the base, allowing the circular body in motion to move slightly forward, upward, backward, and downward within a certain range relative to the base with the suspension. Upper stop points or lower support points or limit springs can restrict the range of motion of the circular body or suspension.

The suspension, serving as a structure to mount the circular body, is flexibly connected to the base. The suspension can be in the form of a flat plate, grid, frame, tube, or rod and may include elasticity. This elasticity can assist in repositioning the suspension or act as an external force on it; it can derive from springs and/or elastic devices, including pneumatic or hydraulic elastic devices. The flexible connection includes gaps or elasticity at the connection, allowing the circular body in motion to move slightly forward, upward, backward, and downward within a certain range relative to the base with the suspension. Limiting devices, such as upper stop points, lower support points, or limit springs, can restrict the range of forward, upward, backward, and downward motion of the circular body or suspension. The circular body, mounted on the suspension, remains suspended in motion, efficiently and stably transferring potential energy.

The flat plate mentioned refers to a flat board, with the circular body mounted on it. The term ‘tubular’ denotes a circular, square, or flat tube. ‘Rod-shaped’ refers to a circular, square, or flat rod. The suspension can also have weights or external forces attached; it may comprise cantilevers, diagonal frames, vertical frames, hanging arms, upper seats, or carriage bars. A cantilever is akin to a human arm, with one end mounting the circular body and the other flexibly connected to the base. A diagonal frame indicates a suspension that is neither horizontally nor vertically mounted on the base. A vertical frame denotes a suspension mounted vertically. A hanging arm refers to a suspension that hangs from the base. The upper seat implies that the base is divided into upper and lower parts or multiple parts, with the upper part being the upper seat. Cantilevers, diagonal frames, vertical frames, or hanging arms can directly utilize or modify the framework structure of the carriage bar 23. The circular body may be movable relative to the suspension.

The potential energy of the circular body refers to the power generated during its motion. The potential energy, or the inertial force of the circular body's motion, encompasses the sum of forces, including the driving force and the circular body's weight, torque, magnetic forces on the body and suspension, and elastic forces. The weight includes the body's own weight and any additional weights attached to it. The torque consists of the motion-induced torque of the body and the torque of the material. The magnetic force includes the attraction and repulsion of electromagnets or magnets. The elastic force encompasses the resilience of elastic materials, springs, and elastic devices. Gears can also be replaced by chain wheels, where the chain wheel transmits power in lieu of two gears.

This application provides multiple interpretations and definitions of the circular body from different perspectives, which are not contradictory. The circular body is an abstract, overarching concept, and its application involves specific physical objects. The circular body should be designated or recognized based on specific circumstances, such as gears, wheels, or cylinders. Any object or device that can amplify the driving force is a circular body.

The circular body has a reasonable pivot point; at this point, the gravitational forces on both sides of the body's gravitational profile are equal, nearly equal, or tend to equalize, making the force required to overcome its static inertia greater than zero or tending towards zero. A reasonable pivot point can lengthen the power arm or shorten the resistance arm and includes positions above gear 26 or gear 27 or where the small wheel 15 is located. A reasonable pivot point also involves having an optimal gravitational profile, the longest possible power arm, or the shortest possible resistance arm. Any object with a reasonable pivot point falls under the concept of the circular body in this invention. The gravitational profile lies along the extended line connecting the pivot point of the circular body and the earth's center.

The described movable connections include well-known axle hole connections, snap connections, sleeve connections, and slide groove connections. Axle hole connections involve components with holes and axles, where the axle can move within the hole, or vice versa, the hole can move around the axle. Examples are scissors and pliers, which use axle hole movable connections. Snap connections are found in mechanisms with snaps or buckles that can move relative to each other. An example is the rear panel of a car that can be conveniently removed-a snap movable connection. Sleeve connections allow for rotation or sliding of an axle within a sleeve, or the sleeve on the axle. Hinges on doors, where the sleeve rotates around the axle, are an example of this type of connection. Sleeve connections can also be axial, such as the bolt action in a rifle. Slide groove connections involve a protrusion sliding within a groove, such as in sliding doors of a vehicle. Movable connections can also have gaps or elasticity at the connection point, allowing components like the upper gear 25, middle gear 26, or suspensions 23 and 28 to move slightly in all directions relative to the base 22.

FIG. 17 is the right view of FIG. 18. The drum 40 is located near the vertical centerline above the pivot wheel 41. There can be one or more pivot wheels 41 beneath the drum 40, aligned axially with the drum and rotating with it. The pivot wheel 41 can be installed on the ground or near the vertical centerline below the drum 40. Auxiliary wheels 42 mounted on the base 43 are located near the horizontal centerline of the drum 40 and can help it rotate smoothly or limit its movement. The auxiliary wheels 42 can also be placed below the drum's horizontal centerline or near the pivot wheel 41. There can be one or more auxiliary wheels 42 around or beneath the drum 40, with the drum's weight primarily resting on the pivot wheel 41, and the auxiliary wheels 42 helping to bear this weight. A driving wheel 44 is installed on the base 43 to drive the drum 40 from the top. The gravitational forces on both sides of the drum 40's gravitational profile are equal or nearly equal. The drum 40 is mounted on a suspension, which can have weights or external forces attached. This suspension is installed on the base 43 or on a ground foundation.

The suspension is movably connected to the base 43. One or more bases 43 are strategically placed around the drum 40, either on its sides or circumferentially. Cross braces 45 are used to integrate two or more bases 43. The base 43 can have devices to limit the movement of the drum 40. The drum can be driven by a driving force applied on its crown, top, or circumference. There may be gaps or elasticity between the ends of the drum 40 and the base 43, or they may be movably connected. Similarly, the bearing seat at the ends of the drum 40 might have gaps or elasticity with the base 43 or be movably connected to it. The pivot wheel 41 can be mounted on the base or a ground foundation. The driving wheel 44, mounted on the suspension, can be accompanied by weights and/or external forces. The drum 40 is positioned either above or near the vertical centerline of the pivot wheel 41. It's possible that the pivot wheel 41 is placed below or outside the vertical centerline of the drum 40, at a distance of 5 mm, 10 mm, 15 mm, or more. The same applies to the positioning of the drum 40 above the pivot wheel 41. The gravitational forces on both sides of the drum 40's gravity profile can be equal or nearly so, or they can be unequal, with the force on the front side of the moving drum being greater or lesser than that on the rear. The pivot wheel 41 can be a gear, friction wheel, sprocket, magnetic wheel, or chain wheel. The drum 40 can be part of a ball mill, dryer, or mixer, and may be located on a suspension and/or above the pivot wheel 41, potentially equipped with a power generation device. The pivot wheel 41's axle might carry a pulley, friction wheel, gear, or coupling to drive a generator. The drum 40 itself can carry gears, pulleys, chains, chain wheels, or friction wheels to drive a generator. The electrical output of the drum 40 can significantly exceed its input. The drum 40 mounted on the suspension can be a cylindrical body. Depending on the distribution of gravity and the force arm on the pivot wheel, the pivot point of the drum 40 on the pivot wheel 41 can be adjusted accordingly. A reasonable pivot point is one that maximizes the force arm, establishes a logical gravity profile, and maximizes the potential energy release of the cylindrical body. Thus, a reasonable pivot point may not necessarily be on or near the vertical centerline but should be determined based on specific conditions.

FIG. 19 is the right view of FIG. 20. The cylindrical body 46 features four protrusions 47 on its circumference. These protrusions 47, a form of convex-concave structures, push levers, connecting rods, pistons, or pedals equipped with a repositioning function, causing them to reciprocate and generate power.

FIG. 21 is the right view of FIG. 22. The cylindrical body 48's circumference is equipped with four ridges 49. These ridges 49, also a type of convex-concave structure, actuate levers, connecting rods, pistons, or pedals that possess a repositioning ability, enabling them to move back and forth to produce power. The ridges 49 can also be designed as rotating wheels. These wheels, a movable convex-concave feature, are mounted on the surface of the cylindrical body 48.

FIG. 23 is the right view of FIG. 24. The cylindrical body 50 is encircled by four sawtooth protrusions 51. These sawteeth, yet another form of convex-concave element, drive levers, connecting rods, transmission bars, or act upon the top of pistons or the surface of pedals. Their reciprocating motion results in the generation of power. The height of these convex-concave elements determines the working stroke of the cylindrical body.

The described cylindrical body can feature one or more convex-concave elements on its surface, including protrusions, ridges, sawteeth, or rotating wheels. The sawteeth refer to saw-like convex-concave elements. These rotating wheels, installable on the cylinder's surface, are capable of rotation. When driven by a force, the cylindrical body can perform reciprocating, rolling, or rotating movements. The convex-concave elements transfer pressure to the actuation points of levers, connecting rods, or transmission bars equipped with automatic repositioning functions, thereby converting the cylindrical body's gravitational and torsional forces, or forces placed upon it, into kinetic energy. Elastic devices around the cylinder, capable of positioning, dampening, or force amplification, may include materials with inherent elasticity, springs, or pneumatic/hydraulic mechanisms. Automatic repositioning can be achieved by installing springs on levers, connecting rods, or transmission bars. In the cylinder's potential energy area, there may be at least one lever, crankshaft, or connecting rod driven by these convex-concave elements. The cylindrical body can be mounted on a base or suspension.

FIG. 26 is the left view and quarter-angle sectional view of FIG. 25. The magnetic flywheel 52 is circled by multiple magnetic induction points 53. The outer ring of magnetic flywheel 52 serves as the base 54, which is equipped with several magnetic induction points 55 corresponding to those on the magnetic flywheel 52. Alternatively, the circumference of magnetic flywheel 52 and base 54 may have one or more commonly known electromagnets or magnet sensing devices, representing the mentioned magnetic induction points. These elements interact with each other; as magnetic flywheel 52 rotates, each magnetic induction point 53 on the flywheel passes over a corresponding point 55 on the base 54. Controlled by known technologies like relays or commutators, the base's magnetic induction points 55 generate attractive or repulsive forces towards the flywheel's magnetic induction points 53, propelling the flywheel's rotation. This mechanism resembles that of a known electric motor, where electromagnetic forces drive the rotor (here represented by magnetic flywheel 52) and the stator (represented by base 54). The magnetic flywheel 52 can be installed on a base or suspension, assisting or becoming the driving force. Additionally, a magnetic circular body can be mounted on the shaft of an electric motor, pulley, gear, or generator. Other configurations might include a flywheel or magnetic flywheel installed between the driving force and the energy-using body, or a circular body shaft equipped with a flywheel or magnetic flywheel.

FIG. 28 is the top view of FIG. 27. The chain wheel 58 is formed by clamping a chain 59 between two plates 56. Multiple pins 57 fix the chain 59 between the two plates 56, and several bolts 60 join the plates 56 together. The described circular body can be a chain wheel, which might be cylindrical, disc-like, ring-like, or gear-like in shape, functioning similarly to gear transmission. Chain wheels are known for their simple structure, ease of maintenance, and low cost. Alternatively, the chain can be linearly mounted on a flat plate, with the driving force moving the chain and plate back and forth to generate power.

FIG. 29 is the left view of FIG. 30. The vertical sleeve 61 has perpendicular holes 62 and 63. This sleeve can act as a sliding sleeve for a suspension system. For example, the sedan bar 23 or 28, made of a round tube, has four vertical sleeves 61 at both ends, sliding into vertical holes 62 for back-and-forth motion. The vertical hole 63 fits over a vertical shaft on the base, allowing up and down movement. Thus, a circular body with a sedan bar can move relative to the base in all directions. The vertical shaft is not shown in the figure.

FIG. 31 is the upward view of FIG. 32. The gear 64 is composed of three stamped parts 66 combined axially. Four bolts 65 secure the three stamped parts 66 together. Gears can also be radially decomposed and reassembled using stamped parts. Additionally, multiple stamped parts can be combined axially and/or radially to form a pulley, a gear, or a circular body in spherical, cylindrical, or bowl shapes, fixed together with bolts 65.

1. An engine comprising a circular body, where the circular body refers to an object that performs circular motion, including spheres or cylinders; alternatively, the circular body could be a pulley, friction wheel, gear, flywheel, or drum, The circular motion includes rotation, rolling, shaking, or swaying, characterized by a driving force through a transmission device that causes at least one circular body to perform circular motion, with the moving circular body outputting its potential energy through the transmission device, The driving force, which is the power that drives the circular body's motion, includes electricity, magnetism, human power, hydraulic power, wind power, or spring power; or the driving force could be the power of an electric motor, internal combustion engine, steam engine, or pneumatic engine, The transmission device includes gears, pulleys, friction wheels, connecting rods, levers, or couplings, The potential energy is the sum of forces generated during the motion of the circular body, including the driving force, the circular body's gravity, and the torque, pull, pressure, or external forces acting on the circular body during motion, The external forces include pulling or pressing forces, magnetism, or elasticity, The potential energy is greater than the driving force; or the potential energy is more than one or three times greater than the driving force, The circular body has an axis and is either positioned on a pivot or mounted on a suspension.

2. The engine as claimed in claim 1, characterized in that the circular body has an axis, with a gap between the axis and the axle hole or the axis being elastic, Alternatively, the circular body at a reasonable pivot, with the gravity on both sides of the circular body's gravity surface being equal or similar, Or the pivot sides are suspended; or the circular body has a suspended area at the pivot; or the circular body can move forwards, backwards, upwards, or downwards on the pivot; or the circular body can move relative to the base in all directions; or the suspension is movably connected to the base; or the suspension is flat, grid-like, or frame-like, The suspension includes cantilevers, inclined frames, vertical frames, hanging arms, upper seats, or sedan bars; or,

2.1. The circular body is drum 40; or there is a gap between the ends of drum 40 and base 43; or drum 40 is elastic; or drum 40 is movably connected to base 43; or there is a gap or elasticity between the bearing seat at the ends of drum 40 and base 43; or the bearing seat at the ends of drum 40 is movably connected to base 43; or drum 40 is located above or near the vertical centerline above pivot wheel 41; or a driving wheel 44 drives drum 40 at the top; or driving wheel 44 is installed on base 43 or suspension; or drum 40 is a drum of a ball mill, dryer, or mixer; or placing the drum of a ball mill, dryer, or mixer on the suspension and/or above pivot wheel 41, equipped with a generator; or the pivot wheel 41 is a gear, friction wheel, tooth hole wheel, or chain wheel; or,

2.2. The circular body is equipped with counterweights and/or external forces, The counterweights include dynamic and static types, The external forces are applied on the circular body, its axis, or related devices, Alternatively, the circular body is a large wheel with smaller wheels inside for cooperation, The circular body may also be elastic, deriving its elasticity from elastic materials, springs, and/or elastic devices, The circular body can be a magnetic flywheel or equipped with magnetic devices, assisting or acting as the driving force, There could be a magnetic circular body between the driving force and the load, The magnetic flywheel 52 has multiple magnetic sensing points 53, The base 54 of the magnetic flywheel 52 has corresponding magnetic sensing points 55, Or the periphery of the flywheel 52 and the base 54 are equipped with electromagnetic or magnet sensing devices, The flywheel 52 serves as a rotor, and the base 54 as a stator; or,

2.3. The circular body is a cylinder mounted on a base or suspension, The cylindrical surface has one or more protrusions, including points, ribs, saw teeth, or wheels, These protrusions drive transmission devices, outputting the cylinder's potential energy; or,

2.4. The circular body is a chain wheel, mounted on a base or suspension via a chain wheel axle, driven by a driving force; or,

2.5. The circular body is circular body 8, an internal gear, The inner perimeter of circular body 8 has multiple gears 9, connected to a base, load, or transmission axle, Gear 9 accepts power from the driving force or circular body 8 or drives circular body 8 and/or limits it, The driving force drives circular body 8, propelling gear 9 to output power, Alternatively, the driving force drives gear 9, transmitting to circular body 8, which then drives another gear 9 for power output, Circular body 8 could be an internal gear with external teeth, having gears 9 and/or 10 on its inner and outer perimeters, These gears, connected to a base, load, or transmission axle, accept power from the driving force or circular body 8, driving circular body 8 and/or limiting it, The driving force propels circular body 8, driving gears 9 and/or 10 for power output, Additionally, circular body 8's inner and/or outer perimeter may have one or more gears 9 and/or 10, The driving force, operating a gear 9 or 10, drives circular body 8, which then drives another gear 9 and/or 10 for power output, There could be a gap and/or elasticity between circular body 8 and gears 9 and/or 10, allowing movement relative to each other, Circular body 8 and/or gears 9 and/or 10 could be mounted on a suspension, Circular body 8 could be an outer ring, rotating around gear 9, with an inner ring gear 11, Inner ring gear 11 is fitted with a central axle 12, one end connected to the inner ring gear 11, the other to a load, A driving force drives circular body 8 or gears 9 or 10, propelling central axle 12 for power output, The inner and outer perimeters of circular body 8 may be fitted with chains, Multiple circular bodies 8 can be axially combined, using the potential energy of one as the driving force for the next; or,

2.6. The circular body referred to is circular body 13, which can be cylindrical, ring-shaped, annular, or tube-shaped, Multiple small wheels 15 are slotted on one or both sides of circular body 13, where they play a role in limiting and/or transmitting motion, These small wheels 15 frictionally drive with circular body 13 and are connected to a base and/or load, The driving force propels circular body 13, causing multiple small wheels 15 to rotate, with at least one wheel connected to the load for power output, Alternatively, the driving force operates at least one small wheel 15, which drives circular body 13, transmitting motion to other small wheels 15, with at least one wheel connected to the load for power output, Circular body 13's inner and/or outer perimeters may be equipped with one or more small wheels 15; or,

2.7. The circular body is circular body 17, shaped like a circular basin, The inner perimeter of circular body 17 has a limiting axle 16 fixedly connected to base 21, which limits circular body 17, A movable friction wheel is mounted on the limiting axle 16, An output axle 18 with a fixed friction wheel is connected to the load, An input axle 19 with a fixed friction wheel is connected to the driving force, collectively positioning circular body 17, The driving force operates input axle 19, whose friction wheel rubs against the inner perimeter of circular body 17, causing it to rotate relative to base 21, The internal friction of circular body 17 drives the friction wheels on limiting axle 16 and output axle 18, The friction wheel on limiting axle 16 idles, while the friction wheel on output axle 18 drives the load for power output, Circular body 17's inner and/or outer perimeters may have one or more limiting axles and/or input axles and/or output axles, Limiting axle 16 and/or output axle 18 and/or input axle 19 may be elastic, The friction transmission can also be a gear, magnetic, sprocket, or chain wheel transmission; the gears can be sprockets, chain wheels, friction wheels, or magnetic wheels; or,

2.8. The circular body is a gear; with upper gear 25, middle gear 26, and lower gear 27 arranged vertically, transmitting motion sequentially, The driving force drives upper gear 25, which in turn drives middle gear 26 and lower gear 27, outputting the potential energy of middle gear 26, An idler gear or idler pulley or coupling is mounted on the middle gear axle 31, directly accepting power from the driving force, Upper gear 25 or middle gear 26 may be mounted on a gantry; or,

2.9. The circular body in question is a pulley, installed on the shaft of an electric motor, a generator, or a pulley shaft, or it forms part of a pulley apparatus comprising a base and at least one pulley shaft mounted on the base, along with driven and driving pulleys on the pulley shaft, Alternately, multiple pulleys of varying diameters can be combined with a high-speed electric motor and a low-speed generator for power generation, In another configuration, a high-speed electric motor combined with a pulley apparatus and a low-speed generator generates power, or the high-speed motor drives a pulley shaft, which in turn powers a low-speed generator, The diameter of the driving pulley may be smaller than that of the driven pulley, The pulley apparatus can be mounted on a suspension, or flywheels or magnetic flywheels can be installed on the shafts of motors, pulleys, or generators, The pulley shaft may have a gap or elasticity relative to its bore, allowing movement, The circular body can also be a wheel axle, including structures like pulleys, gears, sprockets, or flywheels, Additionally, the circular body could be a crankshaft or include a crankshaft, connected to a connecting rod, Multiple circular bodies can be combined, where the potential energy of one acts as the driving force for the next.

3. A manufacturing method for the engine described in claim 1, characterized by positioning the circular body with a shaft or on a reasonable fulcrum, or mounting the circular body on a suspension connected to the base, allowing movement in all directions relative to the base, The driving force, through gears, pulleys, friction wheels, connecting rods, levers, or couplings, induces circular motion in at least one circular body, with these components also transmitting the potential energy of the circular body.
